(19) United States
(12) Patent Application Publication
(10) Pub. No.: US 2025/0175271 A1
(43) Pub. Date: May 29, 2025

(54) PREDICTIVE BEAM MANAGEMENT MODE SWITCHING

(71) Applicant: QUALCOMM INCORPORATED, San Diego, CA (US)

(72) Inventors: Qiaoyu LI, Beijing (CN); Mahmoud TAHERZADEH BOROUJENI, San Diego, CA (US); Tao LUO, San Diego, CA (US)

(21) Appl. No.: 18/837,869

(22) PCT Filed: Apr. 21, 2023
(86) PCT No.: PCT/CN2023/089664

§ 371 Date: Aug. 12, 2024

(30) Foreign Application Priority Data
Apr. 24, 2022 (WO) PCT/CN2022/088713

(51) Int. Cl. H04B 17/373; H04B 7/06; H04B 17/382; H04L 5/00

(52) U.S. Cl. CPC H04B 17/373; H04B 7/0626; H04B 17/382; H04L 5/0048

(57) ABSTRACT

Methods, systems, and devices for wireless communications are described to support predictive beam management mode switching. A user equipment (UE) may proactively request or be indicated to switch beam management modes associated with generation of channel state information (CSI). The UE may request (e.g., or be requested) to switch from using a current beam management mode associated with prediction of CSI to using another beam management mode associated with generation of CSI, for example, based on a change of the operating conditions of the UE or a difference between predicted and measured channel characteristics. Based on the switch, the UE may generate and transmit CSI in accordance with the switched-to beam management mode.

### CROSS REFERENCES

The present Application is a 371 national stage filing of International PCT Application No. PCT/CN2023/089664 by Li et al. entitled “PREDICTIVE BEAM MANAGEMENT MODE SWITCHING,” filed Apr. 21, 2023; and claims priority to International Patent Application No. PCT/CN2022/088713 by Li et al. entitled “PREDICTIVE BEAM MANAGEMENT MODE SWITCHING,” filed Apr. 24, 2022, each of which is assigned to the assignee hereof, and each of which is expressly incorporated by reference in its entirety herein.

### TECHNICAL FIELD

The following relates to wireless communications, including predictive beam management mode switching.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some systems, a UE or base station may utilize machine learning-inference based prediction models for beam management during wireless communication. Performance of such prediction models may degrade, for example, due to a changing wireless communication environment, which may reduce beam management accuracy and performance.

### SUMMARY

The described techniques relate to improved methods, systems, devices, and apparatuses that support predictive beam management mode switching. For example, the described techniques provide for a user equipment (UE) to proactively request or be indicated to switch beam management modes to improve beam management performance. For instance, a UE may be configured to operate according to various beam management modes associated with generation of and reporting CSI, some of which may be associated with respective machine learning models that the UE may use in predicting CSI. In some examples, the UE may be configured to operate according to a first beam management mode and may predict communication characteristics using a machine learning model associated with the first beam management mode that may be or be used to generate CSI that the UE reports to a network entity. In some cases, an accuracy of the machine learning model associated with prediction of the communication characteristics may degrade, for example, due to changing operating conditions of the UE. In response to detecting or foreseeing a degradation of the machine learning model prediction accuracy, the UE may request (e.g., or be requested by the network entity) to switch to a second beam management mode associated with generation of CSI. Based on the request, the UE may switch to the second beam management mode and generate and transmit CSI in accordance with the second beam management mode.

A method for wireless communications at a UE is described. The method may include transmitting first CSI associated with a channel for the UE, the first CSI generated in accordance with a first beam management mode associated with prediction of the first CSI based on a machine learning model associated with the first beam management mode, receiving an indication to switch from the first beam management mode to a second beam management mode associated with generation of second CSI associated with the channel for the UE, switching from the first beam management mode to the second beam management mode based on the indication to switch to the second beam management mode, and transmitting the second CSI associated with the channel for the UE, the second CSI generated in accordance with the second beam management mode based on the switching.

An apparatus for wireless communications at a UE is described. The apparatus may include at least one processor, memory coupled (e.g., operatively, communicatively, functionally, or electrically) to the at least one processor, and instructions stored in the memory. The instructions may be executable by the at least one processor (e.g., directly, indirectly, after pre-processing, without pre-processing) to cause the apparatus to transmit first CSI associated with a channel for the UE, the first CSI generated in accordance with a first beam management mode associated with prediction of the first CSI based on a machine learning model associated with the first beam management mode, receive an indication to switch from the first beam management mode to a second beam management mode associated with generation of channel state information (CSI) associated with the channel for the UE, switch from the first beam management mode to the second beam management mode based on the indication to switch to the second beam management mode, and transmit the CSI associated with the channel for the UE, the CSI generated in accordance with the second beam management mode based on the switching.

Another apparatus for wireless communications at a UE is described. The apparatus may include means for transmitting first CSI associated with a channel for the UE, the first CSI generated in accordance with a first beam management mode associated with prediction of the first CSI based on a machine learning model associated with the first beam management mode, means for receiving an indication to switch from the first beam management mode to a second beam management mode associated with generation of second CSI associated with the channel for the UE, means for switching from the first beam management mode to the second beam management mode based on the indication to switch to the second beam management mode, and means for transmitting the second CSI associated with the channel for the UE, the second CSI generated in accordance with the second beam management mode based on the switching.

A non-transitory computer-readable medium storing code for wireless communications at a UE is described. The code may include instructions executable by a processor (e.g., directly, indirectly, after pre-processing, without pre-processing) to transmit first CSI associated with a channel for the UE, the first CSI generated in accordance with a first beam management mode associated with prediction of the first CSI based on a machine learning model associated with the first beam management mode, receive an indication to switch from the first beam management mode to a second beam management mode associated with generation of second CSI associated with the channel for the UE, switch from the first beam management mode to the second beam management mode based on the indication to switch to the second beam management mode, and transmit the second CSI associated with the channel for the UE, the second CSI generated in accordance with the second beam management mode based on the switching.

Some examples of the method, apparatuses, and non-transitory computer-readable medium described herein may further include operations, features, means, or instructions for transmitting a request to switch to the second beam management mode, where the indication to switch to the second beam management mode may be based on the request.

In some examples of the method, apparatuses, and non-transitory computer-readable medium described herein, transmitting the request to switch to the second beam management mode may include operations, features, means, or instructions for transmitting the request based on a threshold change between a first output of the machine learning model and a second output of the machine learning model, a threshold change between a measurement of a first reference signal received over the channel for the UE and a measurement of a second reference signal received over the channel for the UE, or a combination thereof.

Some examples of the method, apparatuses, and non-transitory computer-readable medium described herein may further include operations, features, means, or instructions for generating, using the machine learning model and in accordance with the first beam management mode, a predicted set of communication characteristics of the channel for the UE, the predicted set of communication characteristics indicating CSI in accordance with the first beam management mode and generating a measured set of communication characteristics of the channel for the UE corresponding to the predicted set of communication characteristics based on a reference signal received over the channel for the UE, where the indication to switch to the second beam management mode may be based on a difference between the predicted set of communication characteristics and the measured set of communication characteristics satisfying a threshold.

In some examples of the method, apparatuses, and non-transitory computer-readable medium described herein, the predicted set of communication characteristics and the measured set of communication characteristics each include a respective set of spatial domain communication characteristics, a respective set of time domain communication characteristics, a respective set of frequency domain communication characteristics, or a combination thereof.

Some examples of the method, apparatuses, and non-transitory computer-readable medium described herein may further include operations, features, means, or instructions for transmitting a request for transmission of the reference signal and receiving the reference signal over the channel for the UE in response to the request.

Some examples of the method, apparatuses, and non-transitory computer-readable medium described herein may further include operations, features, means, or instructions for receiving an activation message indicating transmission of the reference signal and receiving the reference signal over the channel for the UE in response to the activation message.

Some examples of the method, apparatuses, and non-transitory computer-readable medium described herein may further include operations, features, means, or instructions for transmitting a report including the predicted set of communication characteristics and the measured set of communication characteristics or including an indication of the difference between the predicted set of communication characteristics and the measured set of communication characteristics.

In some examples of the method, apparatuses, and non-transitory computer-readable medium described herein, the indication to switch to the second beam management mode may be received in response to the report based on the difference between the predicted set of communication characteristics and the measured set of communication characteristics satisfying the threshold.

Some examples of the method, apparatuses, and non-transitory computer-readable medium described herein may further include operations, features, means, or instructions for transmitting a request to switch to the second beam management mode based on a comparison of the predicted set of communication characteristics and the measured set of communication characteristics to determine the difference between the predicted set of communication characteristics and the measured set of communication characteristics, where the indication to switch to the second beam management mode may be received in response to the request.

In some examples of the method, apparatuses, and non-transitory computer-readable medium described herein, the reference signal may be associated with a time instance for which CSI associated with the time instance may be configured to be predicted in accordance with the first beam management mode.

In some examples of the method, apparatuses, and non-transitory computer-readable medium described herein, the reference signal may be associated with a reference signal resource set for which CSI associated with the reference signal resource set may be configured to be predicted in accordance with the first beam management mode.

Some examples of the method, apparatuses, and non-transitory computer-readable medium described herein may further include operations, features, means, or instructions for generating, using the machine learning model and in accordance with the first beam management mode, a second indication of a set of resources of the channel predicted to have higher communication characteristics relative to other resources of the channel, the communication characteristics including respective reference signal received power (RSRPs) associated with the set of resources, respective signal-to-interference-plus-noise ratios (SINRs) associated with the set of resources, or a combination thereof, and transmitting a report including the second indication of the set of resources, where the indication to switch to the second beam management mode is based on the report.

In some examples of the method, apparatuses, and non-transitory computer-readable medium described herein the report includes a request to switch to the second beam management mode, where the indication to switch to the second beam management mode is based on the request.

In some examples of the method, apparatuses, and non-transitory computer-readable medium described herein, the second beam management mode may be associated with prediction of the second CSI based on a second machine learning model associated with the second beam management mode.

In some examples of the method, apparatuses, and non-transitory computer-readable medium described herein, the second beam management mode may be associated with generation of the second CSI based on a measurement of a reference signal received over the channel for the UE.

In some examples of the method, apparatuses, and non-transitory computer-readable medium described herein, the indication to switch to the second beam management mode may include an indication to deactivate a first type of CSI report associated with the first beam management mode or a first reference signal resource set associated with the first beam management mode and an indication to activate a second type of CSI report associated with the second beam management mode or a second reference signal resource set associated with the second beam management mode.

Some examples of the method, apparatuses, and non-transitory computer-readable medium described herein may further include operations, features, means, or instructions for receiving signaling that indicates the machine learning model associated with the first beam management mode, where the first CSI may be generated using the machine learning model.

A method for wireless communications at a UE is described. The method may include transmitting first CSI associated with a channel for the UE, the first CSI generated in accordance with a first beam management mode associated with prediction of the first CSI based on a machine learning model associated with the first beam management mode and transmitting a request to switch from the first beam management mode to a second beam management mode associated with generation of second CSI associated with the channel for the UE based on the first CSI.

An apparatus for wireless communications at a UE is described. The apparatus may include at least one processor, memory coupled (e.g., operatively, communicatively, functionally, or electrically) to the at least one processor, and instructions stored in the memory. The instructions may be executable by the at least one processor (e.g., directly, indirectly, after pre-processing, without pre-processing) to cause the apparatus to transmit first CSI associated with a channel for the UE, the first CSI generated in accordance with a first beam management mode associated with prediction of the first CSI based on a machine learning model associated with the first beam management mode and transmit a request to switch from the first beam management mode to a second beam management mode associated with generation of second CSI associated with the channel for the UE based on the first CSI.

Another apparatus for wireless communications at a UE is described. The apparatus may include means for transmitting first CSI associated with a channel for the UE, the first CSI generated in accordance with a first beam management mode associated with prediction of the first CSI based on a machine learning model associated with the first beam management mode and means for transmitting a request to switch from the first beam management mode to a second beam management mode associated with generation of second CSI associated with the channel for the UE based on the first CSI.

A non-transitory computer-readable medium storing code for wireless communications at a UE is described. The code may include instructions executable by a processor (e.g., directly, indirectly, after pre-processing, without pre-processing) to transmit first CSI associated with a channel for the UE, the first CSI generated in accordance with a first beam management mode associated with prediction of the first CSI based on a machine learning model associated with the first beam management mode and transmit a request to switch from the first beam management mode to a second beam management mode associated with generation of second CSI associated with the channel for the UE based on the first CSI.

Some examples of the method, apparatuses, and non-transitory computer-readable medium described herein may further include operations, features, means, or instructions for switching from the first beam management mode to the second beam management mode and transmitting the second CSI associated with the channel for the UE, the second CSI generated in accordance with the second beam management mode based on the switching.

Some examples of the method, apparatuses, and non-transitory computer-readable medium described herein may further include operations, features, means, or instructions for receiving an indication to switch from the first beam management mode to the second beam management mode based on the request, where the switching may be based on the indication.

Some examples of the method, apparatuses, and non-transitory computer-readable medium described herein may further include operations, features, means, or instructions for generating, using the machine learning model and in accordance with the first beam management mode, a predicted set of communication characteristics of the channel for the UE, the predicted set of communication characteristics indicating CSI in accordance with the first beam management mode and generating a measured set of communication characteristics of the channel for the UE corresponding to the predicted set of communication characteristics based on a reference signal received over the channel for the UE, where the indication to switch to the second beam management mode may be based on a difference between the predicted set of communication characteristics and the measured set of communication characteristics satisfying a threshold.

In some examples of the method, apparatuses, and non-transitory computer-readable medium described herein, the predicted set of communication characteristics and the measured set of communication characteristics each include a respective set of spatial domain communication characteristics, a respective set of time domain communication characteristics, a respective set of frequency domain communication characteristics, or a combination thereof.

Some examples of the method, apparatuses, and non-transitory computer-readable medium described herein may further include operations, features, means, or instructions for transmitting a request for transmission of the reference signal and receiving the reference signal over the channel for the UE in response to the request for transmission of the reference signal.

Some examples of the method, apparatuses, and non-transitory computer-readable medium described herein may further include operations, features, means, or instructions for receiving an activation message indicating transmission of the reference signal and receiving the reference signal over the channel for the UE in response to the activation message.

Some examples of the method, apparatuses, and non-transitory computer-readable medium described herein may further include operations, features, means, or instructions for transmitting a report including the predicted set of communication characteristics and the measured set of communication characteristics or including an indication of the difference between the predicted set of communication characteristics and the measured set of communication characteristics.

Some examples of the method, apparatuses, and non-transitory computer-readable medium described herein may further include operations, features, means, or instructions for receiving an indication to switch from the first beam management mode to the second beam management mode, where the indication to switch may be received in response to the report based on the difference between the predicted set of communication characteristics and the measured set of communication characteristics satisfying the threshold.

Some examples of the method, apparatuses, and non-transitory computer-readable medium described herein may further include operations, features, means, or instructions for transmitting the request may be based on a comparison of the predicted set of communication characteristics and the measured set of communication characteristics to determine the difference between the predicted set of communication characteristics and the measured set of communication characteristics.

In some examples of the method, apparatuses, and non-transitory computer-readable medium described herein, the reference signal may be associated with a time instance for which CSI associated with the time instance may be configured to be predicted in accordance with the first beam management mode.

In some examples of the method, apparatuses, and non-transitory computer-readable medium described herein, the reference signal may be associated with a reference signal resource set for which CSI associated with the reference signal resource set may be configured to be predicted in accordance with the first beam management mode.

Some examples of the method, apparatuses, and non-transitory computer-readable medium described herein may further include operations, features, means, or instructions for generating, using the machine learning model and in accordance with the first beam management mode, an indication of a set of resources of the channel that are predicted to have higher communication characteristics relative to other resources of the channel, the communication characteristics including respective RSRPs associated with the set of resources, respective SINRs associated with the set of resources, or a combination thereof, where the request to switch to the second beam management mode includes the indication of the set of resources.

In some examples of the method, apparatuses, and non-transitory computer-readable medium described herein, the indication to switch to the second beam management mode may include an indication to deactivate a first type of CSI report associated with the first beam management mode or a first reference signal resource set associated with the first beam management mode and an indication to activate a second type of CSI report associated with the second beam management mode or a second reference signal resource set associated with the second beam management mode.

Some examples of the method, apparatuses, and non-transitory computer-readable medium described herein may further include operations, features, means, or instructions for receiving a message denying the switch from the first beam management mode to the second beam management mode based on the request.

Some examples of the method, apparatuses, and non-transitory computer-readable medium described herein may further include operations, features, means, or instructions for transmitting the request may be based on a threshold change between a first output of the machine learning model and a second output of the machine learning model, a threshold change between a measurement of a first reference signal received over the channel for the UE and a measurement of a second reference signal received over the channel for the UE, or a combination thereof.

In some examples of the method, apparatuses, and non-transitory computer-readable medium described herein, the second beam management mode may be associated with prediction of the second CSI based on a second machine learning model associated with the second beam management mode.

In some examples of the method, apparatuses, and non-transitory computer-readable medium described herein, the second beam management mode may be associated with generation of the second CSI based on a measurement of a reference signal received over the channel for the UE.

Some examples of the method, apparatuses, and non-transitory computer-readable medium described herein may further include operations, features, means, or instructions for receiving signaling that indicates the machine learning model associated with the first beam management mode, where the first CSI may be generated using the machine learning model.

A method for wireless communications at a network entity is described. The method may include obtaining first CSI associated with a channel for communicating with a UE, the first CSI predicted in accordance with a first beam management mode of the UE based on a machine learning model associated with the first beam management mode, outputting an indication for the UE to switch from the first beam management mode to a second beam management mode associated with generation of second CSI associated with the channel, and obtaining the second CSI associated with the channel in accordance with the second beam management mode based on the indication.

An apparatus for wireless communications at a network entity is described. The apparatus may include at least one processor, memory coupled (e.g., operatively, communicatively, functionally, or electrically) to the at least one processor, and instructions stored in the memory. The instructions may be executable by the at least one processor (e.g., directly, indirectly, after pre-processing, without pre-processing) to cause the apparatus to obtain first CSI associated with a channel for communicating with a UE, the first CSI predicted in accordance with a first beam management mode of the UE based on a machine learning model associated with the first beam management mode, output an indication for the UE to switch from the first beam management mode to a second beam management mode associated with generation of second CSI associated with the channel, and obtain the second CSI associated with the channel in accordance with the second beam management mode based on the indication.

Another apparatus for wireless communications at a network entity is described. The apparatus may include means for obtaining first CSI associated with a channel for communicating with a UE, the first CSI predicted in accordance with a first beam management mode of the UE based on a machine learning model associated with the first beam management mode, means for outputting an indication for the UE to switch from the first beam management mode to a second beam management mode associated with generation of second CSI associated with the channel, and means for obtaining the second CSI associated with the channel in accordance with the second beam management mode based on the indication.

A non-transitory computer-readable medium storing code for wireless communications at a network entity is described. The code may include instructions executable by a processor (e.g., directly, indirectly, after pre-processing, without pre-processing) to obtain first CSI associated with a channel for communicating with a UE, the first CSI predicted in accordance with a first beam management mode of the UE based on a machine learning model associated with the first beam management mode, output an indication for the UE to switch from the first beam management mode to a second beam management mode associated with generation of second CSI associated with the channel, and obtain the second CSI associated with the channel in accordance with the second beam management mode based on the indication.

Some examples of the method, apparatuses, and non-transitory computer-readable medium described herein may further include operations, features, means, or instructions for obtaining a request to indicate for the UE to switch to the second beam management mode, where the indication to switch to the second beam management mode may be based on the request.

Some examples of the method, apparatuses, and non-transitory computer-readable medium described herein may further include operations, features, means, or instructions for outputting a reference signal over the channel, the reference signal associated with an instance for which CSI associated with the instance may be configured to be predicted in accordance with the first beam management mode and where the indication for the UE to switch to the second beam management mode may be based on a difference between measured CSI corresponding to the reference signal and predicted CSI corresponding to the reference signal satisfying a threshold.

Some examples of the method, apparatuses, and non-transitory computer-readable medium described herein may further include operations, features, means, or instructions for obtaining a request for transmission of the reference signal, where the reference signal may be output in response to the request.

Some examples of the method, apparatuses, and non-transitory computer-readable medium described herein may further include operations, features, means, or instructions for outputting an indication of transmission of the reference signal, where the reference signal may be output after the indication of the transmission of the reference signal may be output.

Some examples of the method, apparatuses, and non-transitory computer-readable medium described herein may further include operations, features, means, or instructions for obtaining a report including the measured CSI and the predicted CSI or an indication of the difference between the measured CSI and the predicted CSI.

In some examples of the method, apparatuses, and non-transitory computer-readable medium described herein, the indication for the UE to switch to the second beam management mode may be output in response to the report based on the difference between the measured CSI and the predicted CSI satisfying the threshold.

In some examples of the method, apparatuses, and non-transitory computer-readable medium described herein, the reference signal may be associated with a time instance for which CSI associated with the time instance may be configured to be predicted in accordance with the first beam management mode.

In some examples of the method, apparatuses, and non-transitory computer-readable medium described herein, the reference signal may be associated with a reference signal resource set for which CSI associated with the reference signal resource set may be configured to be predicted in accordance with the first beam management mode.

Some examples of the method, apparatuses, and non-transitory computer-readable medium described herein may further include operations, features, means, or instructions for obtaining a report including a second indication of a set of resources of the channel predicted to have higher communication characteristics relative to other resources of the channel, the communication characteristics including respective RSRPs associated with the set of resources, respective SINRs associated with the set of resources, or a combination thereof.

In some examples of the method, apparatuses, and non-transitory computer-readable medium described herein, the second beam management mode may be associated with prediction of the second CSI based on a second machine learning model associated with the second beam management mode.

In some examples of the method, apparatuses, and non-transitory computer-readable medium described herein, the second beam management mode may be associated with generation of the second CSI based on a measurement of a reference signal received over the channel for the UE.

In some examples of the method, apparatuses, and non-transitory computer-readable medium described herein, the indication to switch to the second beam management mode may include an indication to deactivate a first type of CSI report associated with the first beam management mode or a first reference signal resource set associated with the first beam management mode and an indication to activate a second type of CSI report associated with the second beam management mode or a second reference signal resource set associated with the second beam management mode.

### BRIEF DESCRIPTION OF THE DRAWINGS

FIGS. 1 and 2 illustrate examples of wireless communications systems that support predictive beam management mode switching in accordance with one or more aspects of the present disclosure.

FIG. 3 illustrates an example of a beam management mode diagram that supports predictive beam management mode switching in accordance with one or more aspects of the present disclosure.

FIG. 4 illustrates an example of a machine learning process that supports predictive beam management mode switching in accordance with one or more aspects of the present disclosure.

FIGS. 5 and 6 illustrate example flow diagrams that support predictive beam management mode switching in accordance with one or more aspects of the present disclosure.

FIGS. 7 and 8 show block diagrams of devices that support predictive beam management mode switching in accordance with one or more aspects of the present disclosure.

FIG. 9 shows a block diagram of a communications manager that supports predictive beam management mode switching in accordance with one or more aspects of the present disclosure.

FIG. 10 shows a diagram of a system including a device that supports predictive beam management mode switching in accordance with one or more aspects of the present disclosure.

FIGS. 11 and 12 show block diagrams of devices that support predictive beam management mode switching in accordance with one or more aspects of the present disclosure.

FIG. 13 shows a block diagram of a communications manager that supports predictive beam management mode switching in accordance with one or more aspects of the present disclosure.

FIG. 14 shows a diagram of a system including a device that supports predictive beam management mode switching in accordance with one or more aspects of the present disclosure.

FIGS. 15 through 21 show flowcharts illustrating methods that support predictive beam management mode switching in accordance with one or more aspects of the present disclosure.

### DETAILED DESCRIPTION

Some wireless communication systems may support wireless communication by a user equipment (UE) and one or more network entities utilizing machine learning-inference based prediction models (e.g., time, spatial, and/or frequency domain predictions) for beam management. For example, a UE may implement a machine learning model for time domain, spatial domain, and/or frequency domain reference signal received power (RSRP) measurement predictions, among other communication characteristics that may be predicted using machine learning models. Such predictions may be or be used to generate predicted channel state information (CSI), which the UE may report and use in performing beam management with a network entity. Utilizing machine learning model predictions in beam management may reduce overhead and latency, among other benefits, for example, due to not transmitting, or transmitting less frequently, reference signals used to measure and generate the communication characteristics predicted by the machine learning model.

In some cases, however, a machine learning based prediction model may experience decreased prediction accuracy and performance under some conditions. For example, the prediction model may experience a decrease in performance as operating conditions of a UE (e.g., device mobility, or spatial surroundings) stray away from operating conditions within which the prediction model may have been designed (e.g., configured) to operate. For instance, as a UE gains speed and/or enters an area with more obstructions in the surroundings, predictions obtained from the prediction model may be less accurate. Thus, a UE experiencing a decrease in the performance of the prediction model performance may incur issues with beam management, such as decreased beam selection accuracy, decreased accuracy of predicted CSI, increased latency, performance degradation, and a decreased user experience.

In accordance with examples described herein, a UE may proactively request or be indicated to switch beam management modes associated with generating and reporting CSI to improve beam management performance. For example, the UE may operate in a first beam management mode in which the UE may use a machine learning model to predict CSI (e.g., or measurements based on which the UE may generate the CSI). The UE may request (e.g., or be requested) to switch from operating according to the first beam management mode to a second beam management mode, for example, based on a determined performance degradation (e.g., a foreseen or predicted performance degradation) of the machine learning model associated with the first beam management mode. Based on the switch, the UE may generate CSI according to the second beam management mode and transmit the CSI to a network entity. Accordingly, the UE may switch beam management modes to avoid performance decrease caused by prediction inaccuracy of the machine learning model.

In some examples, the UE may request to switch to a beam management mode associated with a different machine learning model (e.g., configured with different parameters for predicting CSI), or to a beam management mode in which reference signals are measured (e.g., instead of predicted) and CSI is generated based on the reference signal measurements. In some examples, the UE may request the mode switch in response to detecting a change (e.g., or future change) in environmental conditions (e.g., faster movement, channel sparsity change, etc.). Additionally or alternatively, the UE may base the decision to request a mode switch on detecting that predicted spatial, time, and/or frequency domain communication characteristics vary substantially (e.g., a difference above some threshold) from actual measurements of these values or previously predicted values. The UE may use these measurements to determine the performance of the prediction model or, alternatively, report the measurements, the predicted values, and/or the difference or error between the measurements and the predicted values, to a network entity. In some cases, the network entity may determine to request the UE to perform the mode switching based on the reported information.

Particular implementations of the subject matter described in this disclosure can be implemented to realize on or more of the following potential advantages. In some implementations, for example, the UE may switch from using a beam management mode to avoid experiencing a loss of performance and issues with beam management, while supporting the use of machine learning models for beam management. As such, the UE may support increased beam selection and CSI reporting accuracy and performance, decreased latency, reduced signaling overhead, improved coordination between devices, reduced power consumption, and an increased user experience, among other benefits, even in changing conditions, such as high mobility environments or environments having spatial obstructions.

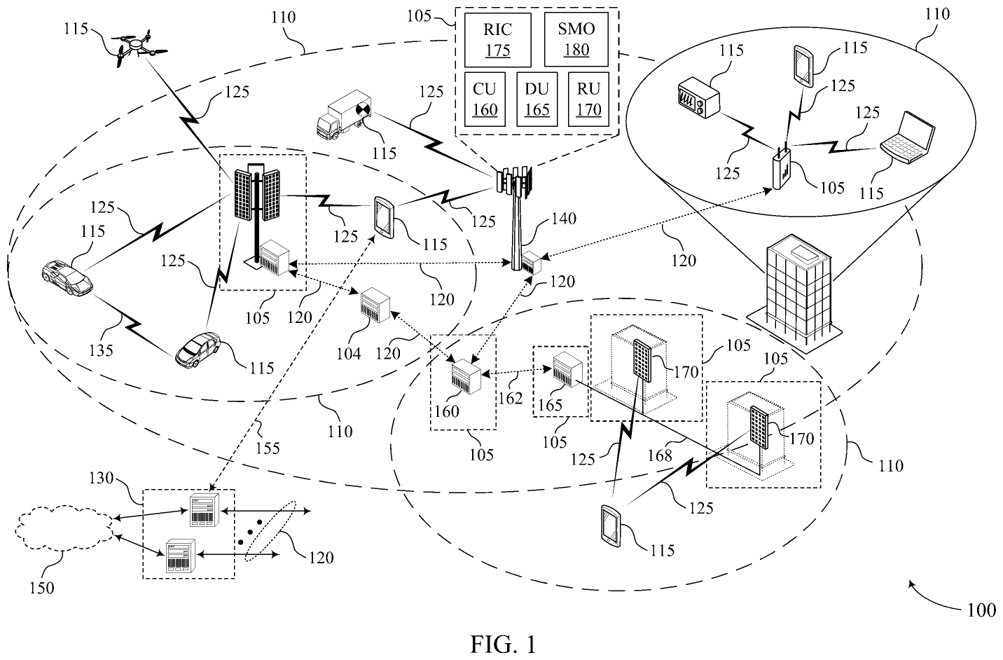

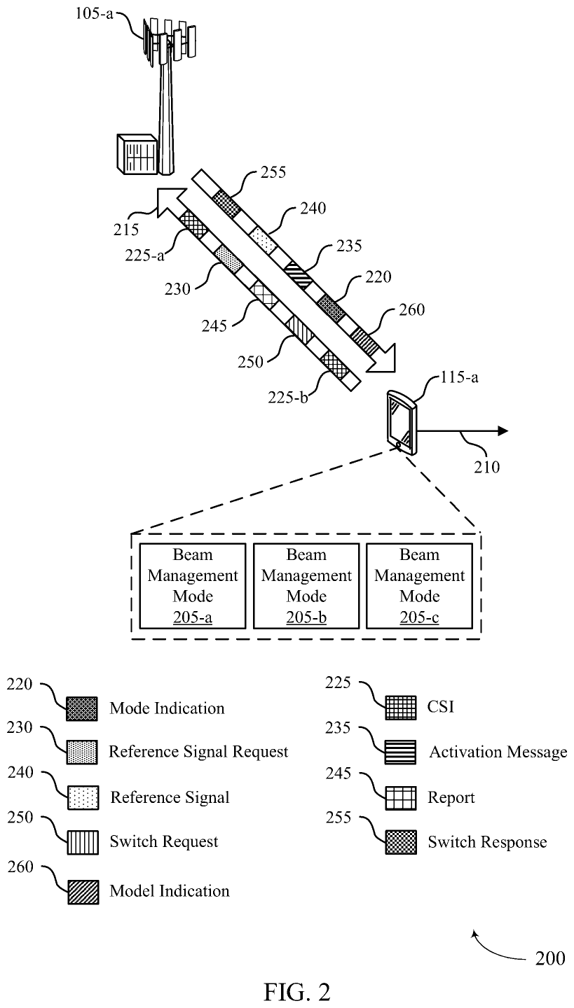

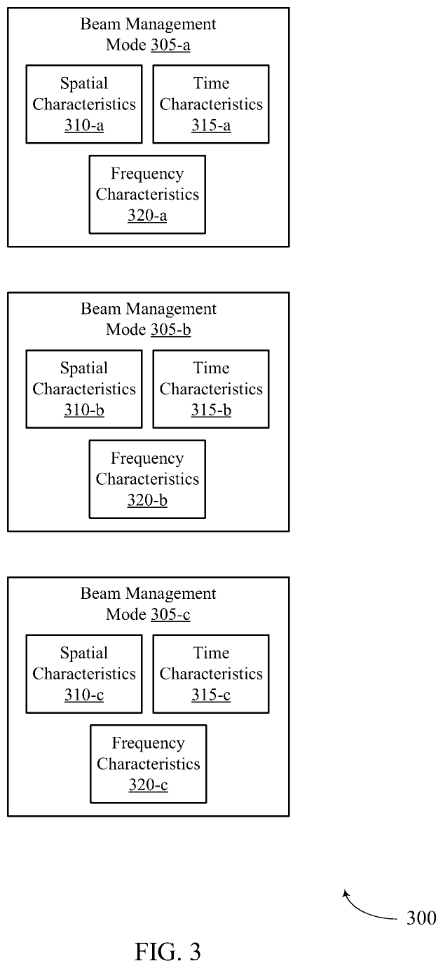

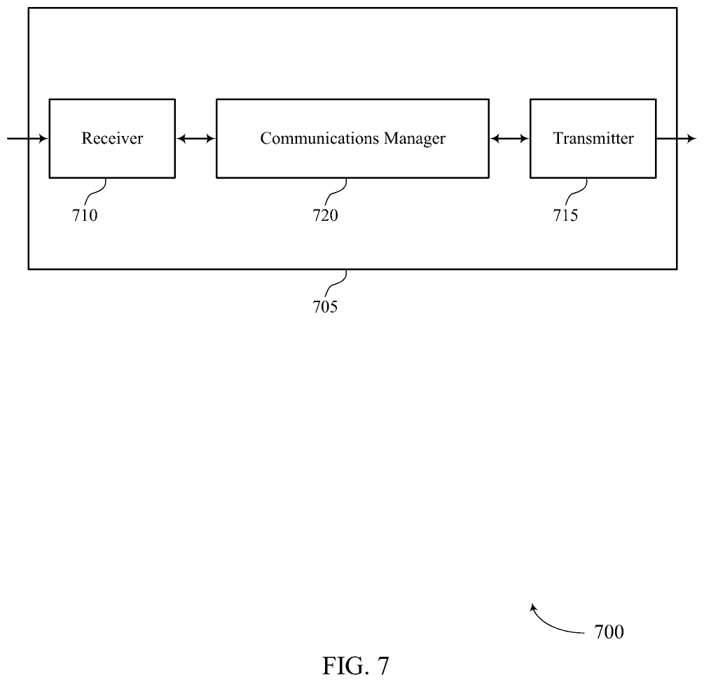

Aspects of the disclosure are initially described in the context of wireless communications systems with reference to FIGS. 1 and 2. Features of the disclosure are additionally described in the context of a beam management mode diagram, a machine learning process, and process flows with reference to FIGS. 3 through 6. Aspects of the disclosure are further illustrated by and described with reference to apparatus diagrams, system diagrams, and flowcharts that relate to predictive beam management mode switching with reference to FIGS. 7 through 21.

FIG. 1 illustrates an example of a wireless communications system 100 that supports predictive beam management mode switching in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support predictive beam management mode switching as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, drones, or robots, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may support the communication of CSI between communication devices. For example, communication devices (e.g., network entities 105, UEs 115) may exchange CSI (e.g., a network entity 105 may gather CSI from a UE 115, UEs 115 may exchange CSI) to efficiently configure and schedule the channel. In some examples, this information may be sent from a UE 115 in the form of a CSI report. A CSI report may contain: a rank indicator (RI) requesting a number of layers to be used for transmissions (e.g., based on antenna ports of the UE 115): a layer indicator (L1) indicating a strongest layer of the number of layers requested by the RI: a precoding matrix indicator (PMI) indicating a preference for which precoder matrix should be used (e.g., based on a number of layers): a channel quality indicator (CQI) representing a highest MCS that may be used: a CSI-RS resource indicator (CRI) indicating a preferred beam for communicating with a communication device (e.g., a network entity 105, another UE 115): a synchronization signal block (SSB) resource indicator (SSBRI) indicating an SSB that the UE 115 receives with a highest received power (e.g., reference signal received power (RSRP), or a combination thereof.

In some cases, an RI may be associated with a number of antennas used by a device. CQI may be calculated by a UE 115 in response to receiving predetermined pilot symbols such as CRSs or CSI-RSs. RI and PMI may be excluded if the UE 115 does not support spatial multiplexing (or is not in a supported spatial mode). In some examples, the types of information included in the CSI report may determine a reporting type. In some examples, a CSI report may be periodic, aperiodic, or semi-persistent.

In some aspects, the wireless communications system 100 may support wireless communication by a UE 115 and one or more network entities 105 utilizing machine learning-inference based prediction models (e.g., time, spatial, and/or frequency domain predictions) for beam management. In some cases, however, a prediction model may experience decreased prediction accuracy and performance under certain conditions. For example, as operating conditions (e.g., speed, or spatial surroundings, among other examples) of a UE 115 change and stray away from conditions within which the prediction model may have been configured to operate, the prediction model may experience a decrease in prediction accuracy or otherwise decrease in performance. As a result, the UE 115 may experience a decrease in the performance of the prediction model performance, which may incur issues with beam management, such as decreased beam selection accuracy, decreased CSI prediction accuracy, increased latency, performance degradation, and a decreased user experience.

Various aspects of the described techniques support a UE 115 or a network entity 105 proactively requesting or indicating, respectively, for the UE 115 to switch beam management modes in response to degradation (e.g., foreseen degradation) in performance of a prediction model. For example, the UE 115 may be configured to operate according to various beam management modes for generating CSI. For instance, the UE 115 may be configured to operate according to one or more beam management modes in which the UE 115 uses a respective machine learning model (e.g., prediction model) to predict communication characteristics of a channel, which may be or be used to generate CSI for the channel. Additionally or alternatively, the UE 115 may be configured to operate according to a beam management mode in which the UE 115 measures reference signals and generates CSI for the channel based on the reference signal measurements.

The UE 115 may request (e.g., or be requested by the network entity 105) to switch from operating according to a first (e.g., current) beam management mode to a second beam management mode, for example, in response to a detected or foreseen degradation in the performance of the first beam management mode. For example, in accordance with the first beam management mode, the UE 115 may predict and report CSI using a first machine learning model. The UE 115, the network entity 105, or both, may detect or foresee a degradation in an accuracy of the CSI generated in accordance with the first beam management mode and may request for the UE 115 to switch to the second beam management mode as a result. Accordingly, the UE 115 may switch beam management modes to avoid or mitigate performance decrease caused by machine learning model prediction inaccuracy.

In some examples, the UE 115 may request or be requested to switch to another beam management mode in response to the UE 115 or network entity 105 detecting a change in environmental conditions. Additionally or alternatively, the UE 115 or the network entity 105 may detect that predicted communication characteristics (e.g., time, frequency, or spatial communication characteristics) vary substantially from measured or previously predicted values of the communication characteristics. The UE 115 or network entity 105 may evaluate the performance of a current beam management mode based on these values and request for the UE 115 to switch to another beam management mode.

FIG. 2 illustrates an example of a wireless communications system 200 that supports predictive beam management mode switching in accordance with one or more aspects of the present disclosure. The wireless communications system 200 may implement or be implemented by aspects of wireless communications system 100 as described with reference to FIG. 1. For example, the wireless communications system 200 may include a UE 115-a and a network entity 105-a, which may be examples of the corresponding devices described herein, including with reference to FIG. 1

The wireless communications system 200 may support communication between the UE 115-a and the network entity 105-a. For example, the UE 115-a and the network entity 105-a may communicate messages using communication links 215, which may be examples of a communication link 125 described herein, including with reference to FIG. 1. The UE 115-a and the network entity 105-a may also support beamformed communications. For example, the UE 115-a and the network entity 105-a may transmit and receive messages using one or more respective beams selected, for example, in accordance with a beam selection procedure (e.g., to select corresponding beamforming weight sets).

The UE 115-a may support performing beam management according to various beam management modes 205. In some cases, the UE 115-a may generate communication characteristics based on predictions obtained using a machine learning model associated with an active beam management mode 205. In some examples, the communication characteristics may be or include beam characteristics, channel characteristics, or CSI, for example, and may include information associated with a channel used for communications between the UE 115-a and the network entity 105-a. For example, the UE 115-a may use the machine learning model to predict the communication characteristics, which may include one or more of a layer 1-RSRP (L1-RSRP), an L1-signal-to-interference-plus-noise ratio (L1-SINR), an RI, an L1, a PMI, or a CQI and may be, or be used to generate, CSI for the channel.

A beam management mode 205 may correspond to a set of instructions and/or parameters for the UE 115-a to determine communication characteristics associated with a beam or the channel and to report the communication characteristics to the network entity 105-a, as described in more detail below with reference to FIG. 3. In some cases, the beam management mode 205 to be used by the UE 115-a may be signaled (e.g., activated) by the network entity 105-a via a mode indication 220. For example, the network entity 105-a may transmit, to the UE 115-a, a mode indication 220 that includes an indication of a beam management mode 205-a (e.g., an identifier (ID) associated with the beam management mode 205-a) to signal the UE 115-a to operate according to the beam management mode 205-a for performing beam management and reporting. The beam management mode 205-a may be associated with a first machine learning model that the UE 115 may use to predict CSI 225-a (e.g., spatial domain, time domain, and/or frequency domain communication characteristics based on which the UE 115-a may generate the CSI 225-a). Accordingly, based on the mode indication 220, the UE 115-a may generate and transmit the CSI 225-a in accordance with the beam management mode 205-a.

In some examples, the first machine learning model (e.g., and machine learning models associated with other beam management modes 205, such as a beam management mode 205-b) may be configured or indicated by the network entity 105-a. For example, the network entity 105-a may output (e.g., transmit) a model indication 260 to the UE 115-a that indicates the first machine learning model (e.g., and additional machine learning models, such as a second machine learning model associated with the beam management mode 205-b). The model indication 260 may indicate to which beam management mode 205 the machine learning models correspond.

In some cases, the UE 115-a may experience a range of operating conditions that may affect the performance of the first machine learning model associated with the active beam management mode 205-a. For example, the machine learning model may be configured to perform under certain speeds (e.g., 3 kilometers per hour), and the UE 115-a may engage in movement 210 exceeding these speeds. Additionally or alternatively, the first machine learning model may be designed to perform at or below a certain level of obstructions present in the surroundings of the UE 115-a. As the UE 115-a strays away from the conditions within which the first machine learning model was configured to perform, the beam management mode 205-a may decrease in performance and accuracy of its predictions. The UE 115-a, the network entity 105-a, or both, may evaluate or predict the performance of the beam management mode 205-a based on detecting or foreseeing a change in operating conditions (e.g., increased movement 210, increased obstructions, increased multipath measurements, poorer channel sparsity, among others), comparing predicted communication characteristics with previously predicted communication characteristics or with actually measured communication characteristics, or a combination thereof.

Based on detecting or foreseeing a degradation in performance of the first machine learning model, the UE 115-a may switch from the beam management mode 205-a to another beam management mode 205. For example, the UE 115-a may switch to the beam management mode 205-b or the beam management mode 205-c and may generate and transmit CSI 225-b in accordance with the switched-to beam management mode 205. The switched-to beam management mode 205 may be associated with increased beam management accuracy relative to the beam management mode 205-a for the operating conditions of the UE 115-a. For example, the beam management mode 205-b may be associated with the second machine learning model that is configured to perform under different operating conditions than the first machine learning model that more closely correspond to the operating conditions of the UE 115-a that triggered the switching. The beam management mode 205-c may be a beam management mode 205 in which the UE 115-a generates CSI 225-b based on measurements of one or more reference signals 240 transmitted by the network entity 105-a. As such, the UE 115-a may generate CSI 225 that more closely corresponds to the operating conditions of the UE 115-a that triggered the switching. Accordingly, by switching beam management modes 205, the UE 115-a may improve beam management performance and accuracy.

When the UE 115-a is operating according to the beam management mode 205-a, the UE 115-a may be configured to predict future communication characteristics, communication characteristics for reference signal resource sets (e.g., CSI-RS resource sets), or both. As such, the network entity 105-a may refrain from transmitting some reference signals 240 over resources (e.g., CSI-RS resources, synchronization signal block (SSB) resources) for measuring communication characteristics that the UE 115-a is configured to predict. To support evaluating the prediction accuracy of the beam management mode 205-a, however, the network entity 105-a may transmit one or more of these reference signals 240 despite the UE 115-a being configured to predict the communication characteristics associated with the reference signals 240. As a result, the UE 115-a may compare predicted communication characteristics with communication characteristics measured using the received reference signals 240).

In some examples, the UE 115-a may transmit a reference signal request 230 indicating to (e.g., requesting for) the network entity 105-a to transmit one or more reference signals 240 over one or more of the resources. For example, the UE 115-a may determine that the prediction uncertainty of the beam management mode 205-a is increasing and decide to proactively request transmission of one or more reference signals 240 for evaluating the beam management mode 205-a by sending the reference signal request 230. The network entity 105-a may transmit the one or more reference signals 240 (e.g., an aperiodic (AP) reference signal or a semi-persistent (SP) reference signal) in response to receiving the reference signal request 230. In some examples, the network entity 105-a may send an activation message 235 prior to the transmission of the one or more reference signals 240 to activate (e.g., trigger) the UE 115-a to receive the one or more reference signals 240.

In some cases, the UE 115-a may request activation of one or more preferred resources for transmission of the one or more reference signals 240. For example, the UE 115-a may request activation of one or more future time instances, which may be associated with a resource set (e.g., a periodic, a AP, or SP CSI-reference signal (RS) resource set, an SSB resource set, a non-zero power (NZP) CSI-RS resource set, or any combination thereof) configured by the network entity 105-a. In some examples, the UE 115-a may request activation of one or more resource sets or transmission of one or more reference signals 240 one or more resource sets. The preferred resources may be selected based on slot offsets or periodicities in the configured resource sets and may correspond to instances (e.g., time instances, resources) for which the UE 115-a may have been scheduled to predict communication characteristics using the first machine learning model. In some examples, the network entity 105-a may indicate the activated resources for transmission of the one or more reference signals 240, for example, via the activation message 235.

In some cases, the network entity 105-a may order the UE 115-a to perform additional measurements by transmitting a reference signal 240 without receiving a reference signal request 230 from the UE 115-a. For example, the network entity 105-a may determine that predictions and reports received from the UE 115-a (e.g., a spatial domain strongest L1 reference signal received power (L1-RSRP) predictions) are straying further from measurements performed by the network entity 105-a (e.g., sounding reference signal (SRS) measurements). The network entity 105-a may transmit one or more additional reference signals 240 (and, in some cases, a preceding activation message 235) for the UE 115-a to perform additional measurements to evaluate the performance of the beam management mode 205-a without the UE 115-a transmitting a reference signal request 230. The network entity 105-a may select the one or more reference signals 240 corresponding to resources associated with communication characteristics to be predicted by the UE 115-a.

The UE 115-a may measure communication characteristics using the received one or more reference signals 240 and associate the measurements with corresponding predicted communication characteristics. In some examples, the network entity 105-a may transmit one or more reference signals 240 over the resources requested by the UE 115-a corresponding to predicted communication characteristics, so that each time instance or slot corresponds to a prediction performed or to be performed by the UE 115-a.

In some cases, the UE 115-a may send a report 245 to the network entity 105-a. The report 245 may contain, for example, the predicted communication characteristics, the actual communication characteristics obtained from the measurement of the one or more reference signals 240, a difference (e.g., error) between the predicted and measured communication characteristics, changes in the operating conditions of the UE 115-a, CSI 225 generated based on the one or more reference signals 240, or any combination thereof. In some examples, the activation message 235 may trigger the UE 115-a to transmit the report 245. In some cases, the network entity 105-a may send a mode indication 220 to request the UE to switch to a new beam management mode (e.g., beam management mode 205-b, beam management mode 205-c) in response to the report 245. For example, the network entity 105-a may compare the predicted and measured communication characteristics to determine that the difference satisfies (e.g., meets or exceeds) a threshold (e.g., configured by a network or the network entity 105-a, or otherwise stored at the UE 115-a). Alternatively, the network entity 105-a may compare the reported difference to threshold to determine that the difference satisfies the threshold.

Additionally or alternatively, the UE 115-a may determine to send a switch request 250 requesting to switch to the new beam management mode 205, for example, based on a change in the operating conditions of the UE 115-a, the predicted communication characteristics, the measured communication characteristics, the difference between the predicted and measured communication characteristics (e.g., satisfying the threshold), or any combination thereof. The switch request 250 may contain an indication (e.g., an ID) of the beam management mode 205 to which the UE 115-a proposes to switch. The UE 115-a may additionally send the report 245 containing the information used to determine to send the switch request 250. In some cases, the switch request 250 may be sent together with the report 245. For example, a number of bits may be reserved in the report 245 for indicating whether a request is sent, the type of request, and/or the contents of the switch request 250. Alternatively, the switch request 250 may be sent separately from the report 245 (e.g., through a physical uplink control channel (PUCCH) scheduling request or a medium access control (MAC) control element (MAC-CE)).

In some examples, the report 245 or the switch request 250 may include an indication of a set of resources of the channel (e.g., time and/or frequency resources of the channel) that are predicted to have better (e.g., higher) communication characteristics relative to other resources of the channel or that are predicted to satisfy a threshold. For example, the reported prediction communication characteristics may include UE predicted top K resources, such as in terms of their L1-RSRP values, L1-SINR values, or a combination thereof (e.g., without including any explicit L1-RSRP or L1-SINR values), where K is a positive integer. For instance, using the machine learning model, the UE 115-a may predict (e.g., generate a prediction of) the K resources of the channel that have (e.g., will have) the highest communication characteristics (e.g., in terms of L1-RSRP values and/or L1-SINR values) relative to remaining resources of the channel (e.g., for which the UE 115-a is to report associated CSI) or that satisfy a threshold (e.g., a threshold L1-RSRP and/or a threshold L1-SINR). In some examples, the UE 115-a may be configured to predict the top K resources of the channel (e.g., corresponding to the top K transmit beams of the network entity 105-a and/or the top K transmission configuration indicator (TCI) states used by the UE 115-a) in terms of their L1-RSRP and/or L1-SINR measurements based on a measurement of N resources of the channel, where N is a positive integer that is less than K. That is, the UE 115-a may measure a subset of resources of the channel (e.g., corresponding to a subset of transmit beams of the network entity 105-a and TCI states of the UE 115-a) and predict the top K resources of the channel, which may include resources that the UE 115-a does not actually measure but are included in the prediction based on the machine learning model. In some examples, the UE 115-a may propose to switch to a beam management mode 205 that relies on a different machine learning model than the beam management mode 205-a. For example, in accordance with the beam management mode 205-a, the UE 115-a may be configured to predict an L1-RSRP measurement at every 20 ms of a CSI-RS resource set that is measured every 160 ms. The UE 115-a may determine that it is moving (e.g., or will move) faster and propose a switch to the beam management mode 205-b that is associated with more frequent reception of resource sets (e.g., CSI-RS resource sets) for measurement (e.g., every 80 ms instead of 160 ms). Additionally or alternatively, in accordance with the beam management mode 205-a, the UE 115-a may be configured to predict an L1-RSRP measurement of 12 CSI-RS resources based on a measurement of 4 CSI-RS resources. If the UE 115-a determines that channel sparsity is worsening, the UE 115-a may propose (e.g., request) a switch to the beam management mode 205-b that performs measurements on a larger number of resources (e.g., measures 8 CSI-RS resources and predicts L1-RSRP for 8 CSI-RS resources).

In some examples, the UE 115-a may propose to switch to a beam management mode 205-c that is based on measurements for determining communication characteristics and does not rely on predictions from a machine learning model. For example, in accordance with the beam management mode 205-a, the UE 115-a may be configured to predict beam failure in a first serving cell at 28 GHz based on L1-RSRP measurements predicted based on actual L1-RSRP measurements in a second serving cell at 3.5 GHz. If the UE 115-a determines that a measured L1-RSRP of reference signals in the first serving cell is consistently higher than the predicted L1-RSRP measurement, the UE 115-a may propose a switch to the beam management mode 205-c that relies on measurements from the first serving cell. In some examples, if the UE 115-a determines that the available beam management modes 205 reliant on machine learning models would not result in an improvement (e.g., a threshold improvement), the UE 115-a mat request to switch to the beam management mode 205-c. In the cases where the network entity 105-a requests for the UE 115-a to perform a beam management mode switch, the network entity 105-a may similarly determine a beam management mode 205 to request.

The network entity 105-a may send a switch response 255 to the UE 115-a in response to the switch request 250. In some cases, the network entity 105-a may accept the request. For example, the switch response 255 may be or contain feedback or a mode indication 220 to signal the UE 115-a to perform the switch. The UE 115-a may perform the switch and report CSI 225 (e.g., CSI 225-b) in accordance with the new beam management mode 205. Alternatively, the switch response 255 may be a denial of the switch request 250 sent by the UE 115-a. For example, the network entity 105-a may determine that the UE 115-a should not perform the switch based on the information received in the report 245 (e.g., not exceeding a threshold). The UE 115-a may then continue to report CSI 225 in accordance with the beam management mode 205-a.

FIG. 3 illustrates an example of a beam management mode diagram 300 that supports predictive beam management mode switching in accordance with one or more aspects of the present disclosure. The beam management mode diagram 300 may be implemented by aspects of the wireless communications systems 100 and 200. For example, the beam management mode diagram 300 may be implemented by a UE 115 and a network entity 105 as described herein, including with reference to FIGS. 1 and 2. The beam management mode diagram 300 illustrates example beam management modes 305-a, 305-b, and 305-c, which may be examples of a beam management mode 205 as described herein, including with reference to FIG. 2.

A UE 115 may be configured with multiple beam management modes 305 for performing beam management procedures. For example, the UE 115 may receive information comprising one or more beam management modes 305, which may include machine learning models, from a network entity 105. In some examples, the network entity 105 may determine and distribute one or more machine learning models associated with one or more of the beam management modes 305 to the UE 115. A beam management mode 305 may be associated with one or more IDs (e.g., a CSI report setting ID, a resource setting ID, a BWP-ID, a ServCell-ID, or a combination thereof). The IDs associated with the beam management modes 305 may be used by the UE 115 and the network entity 105 to identify beam management modes 305 in communications. For example, the UE 115 may request to switch to a beam management mode 305 by indicating at least one of the IDs associated with the beam management mode 305-b to the network entity 105. Similarly, the network entity 105 may signal the UE 115 to switch to a beam management mode 305 by indicating at least one of the IDs associated with the beam management mode 305. Additionally or alternatively, the network entity 105 may deactivate a type of CSI report or a CSI resource set associated with a first beam management mode 305 that is currently in use by the UE 115, and activate a type of CSI report or a CSI resource set associated with a second beam management mode 305 to which the UE 115 is to switch.

The beam management modes 305 may correspond to a set of instructions and/or parameters for the UE 115 to determine spatial characteristics 310, time characteristics 315, and/or frequency characteristics 320 associated with a beam or channel and settings for reporting (e.g., CSI report settings) the characteristics to the network entity 105. The spatial characteristics 310 may correspond to spatial domain beam or channel characteristics, the time characteristics 315 may correspond to time domain beam or channel characteristics, and the frequency characteristics 320 may correspond to frequency domain beam or channel characteristics. For example, the characteristics may include one or more of an L1-RSRP, an L1-SINR, an RI, an L1, a PMI, or a CQI, that are generated (e.g., measured or predicted) in accordance with spatial domain, time domain, and/or frequency domain parameters for generating the characteristics that are associated with a respective beam management mode.

For example, a beam management mode 305-a may be associated with a first machine learning model including spatial, time, and/or frequency values or offsets for predicting (e.g., generating) spatial characteristics 310-a, time characteristics 315-a, and frequency characteristics 320-a, respectively. For instance, the beam management mode 305-a may be associated with a first set of time domain parameters that indicate how often the UE 115 is to predict the time characteristics 315-a and how often the UE 115 is to measure the time characteristics 315-a. For example, if operating according to the beam management mode 305-a, the UE 115 may be configured to use the first machine learning model with inputs being time series L1-RSRP measurements of CSI-RS resources #1-#8 at every 80 ms, and with outputs being L1-RSRP measurements every 20 ms between measurement occasions. The UE 115 may be further configured with a CSI report having a reporting periodicity of 20 ms and, for example, whose report quantity includes L1-RSRP measurements corresponding to CSI-RS resources #1-#8, where the UE may report predicted L1-RSRP measurements during the non-measurable instances.

Additionally or alternatively, the beam management mode 305-a may be associated with a first set of spatial domain parameters that indicate for which CSI-RS resource sets the UE 115 is to predict the spatial characteristics 310-a. For example, if operating according to the beam management mode 305-a, the UE 115 may be configured to use the first machine learning model with inputs being L1-RSRP measurements of a first CSI-RS resource set, and with outputs being L1-RSRP predictions of a second CSI-RS resource set (e.g., with the second CSI-RS resource set being a ZP-CSI-RS resource set, for example, to reduce overhead). The UE may be further configured with a CSI report whose report quantity includes predicted RSRP measurements associated with the second CSI-RS resource set.

Additionally or alternatively, the beam management mode 305-a may be associated with a first set of frequency domain parameters that indicate for which CSI-RS resource sets the UE 115 is to predict the frequency characteristics 320-a. For example, if operating according to the beam management mode 305-a, the UE 115 may be configured predict L1-RSRP measurements for a first CSI-RS resource set associated with a first BWP or a first serving cell based on measurements of a second CSI-RS resource set associated with a second BWP or a second serving cell. For instance, the UE may be configured to use the first machine learning model with inputs being an angle of arrival (AoA) or power delay profile (PDP) estimated from the second CSI-RS resource set, and with outputs being L1-RSRP predictions of the first CSI-RS resource set (e.g., with the first CSI-RS resource set being a ZP-CSI-RS resource set, for example, to reduce overhead). The UE may be further configured with a CSI report whose report quantity includes predicted RSRP measurements associated with the first CSI-RS resource set.

In some examples, the UE 115 may request for or be indicated transmission of one or more reference signals for evaluating whether the UE 115 should switch to another beam management mode 305, as described with reference to FIG. 2. In some examples, the reference signals transmitted may be based on which resources for which characteristics are predicted and which resources for which characteristics are measured in accordance with the beam management mode 305-a.

For example, with regards to the time domain, the UE 115 may also be configured with two different SP CSI-RS resource sets that include the same CSI-RS resources #1-#8 associated with the configured CSI report. The first CSI-RS resource set may have a periodicity of 160 slots and an offset such that it overlaps with the time instances for which the UE 115 predicts the L1-RSRP measurements. The second CSI-RS resource set may have a periodicity of 320 slots and an offset such that it overlaps with one or more of the time instances for which the UE 115 predicts the L1-RSRP measurements. The UE 115 may indicate (e.g., or be indicated) one of the SP CSI-RS resource set in a request (e.g., a reference signal request 230, an activation message 235) and may optionally indicate a preferred activation/deactivation slot for the preferred CSI-RS resource set. Alternatively, the UE 115 may be configured with an AP CSI-RS resource set that includes the same CSI-RS resources #1-#8 associated with the configured CSI report. The UE may indicate the AP CSI-RS resource set in the request and may optionally indicate one or more preferred triggering slots.

Additionally or alternatively, with regards to the spatial domain, the UE may also be further configured with one or multiple third SP or AP NZP-CSI-RS resource sets that mimic the second CSI-RS resource set (e.g., the ZP-CSI-RS resource set). The UE 115 may indicate one of the third CSI-RS resource sets in the request and may optionally indicate a preferred activation/deactivation slots for the indicated SP CSI-RS resource set or one or more preferred triggering slots for the indicated AP CSI-RS resource set.

Additionally or alternatively, with regards to the frequency domain, the UE may also be further configured with one or multiple third SP or AP NZP-CSI-RS resource sets that mimic the first CSI-RS resource set (e.g., the ZP-CSI-RS resource set). The UE 115 may indicate one of the third CSI-RS resource sets in the request and may optionally indicate a preferred activation/deactivation slots for the indicated SP CSI-RS resource set or one or more preferred triggering slots for the indicated AP CSI-RS resource set.

Based on the request, the UE 115 may measure the additionally transmitted reference signals over the activated resources for comparison against the predicted measurements. Based on the comparison, the UE 115 may request or be requested to switch to another beam management mode 305, such as a beam management mode 305-b or a beam management mode 305-c.

The beam management mode 305-b may rely on a different machine learning model (e.g., a machine learning model associated with different parameters) to predict and generate spatial characteristics 310-b, time characteristics 315-b, and frequency characteristics 320-b. For example, beam management mode 305-b may use a shorter or longer time interval than beam management mode 305-a in between predicted time characteristics 315-b and a most recent measurement of the time characteristics 315-b. Additionally or alternatively, the beam management mode 305-b may use denser or sparser spatial domain measurements relative to the beam management mode 305-a as inputs to the machine learning model for predicting spatial characteristics 310-b. Additionally or alternatively, the beam management mode 305-b may use a larger or smaller frequency offset in between measurements relative to the beam management mode 305-a as inputs to the machine learning model for predicting frequency characteristics 320-b.

The beam management mode 305-c may involve performing measurements to determine spatial characteristics 310-c, time characteristics 315-c, and frequency characteristics 320-c, and refrain from using a machine learning model for predicting the channel characteristics. In some examples, the beam management mode 305-c may be associated with different parameters for reporting communication characteristics than beam management modes 305-a and 305-b. For instance, in accordance with the beam management mode 305-c, the UE 115 may perform measurements and transmit reports (e.g., CSI reports, L1-RSRP measurements) with a 20 millisecond beam management cycle (e.g., or some other beam management cycle). In accordance with the beam management mode 305-a, the UE 115 may predict and transmit reports (e.g., including predicted L1-RSRP measurements) with an 80 ms beam management cycle (e.g., or some other beam management cycle). In accordance with the beam management mode 305-b, the UE 115 may predict and transmit reports (e.g., including predicted L1-RSRP measurements) with a 40 ms beam management cycle (e.g., or some other beam management cycle).

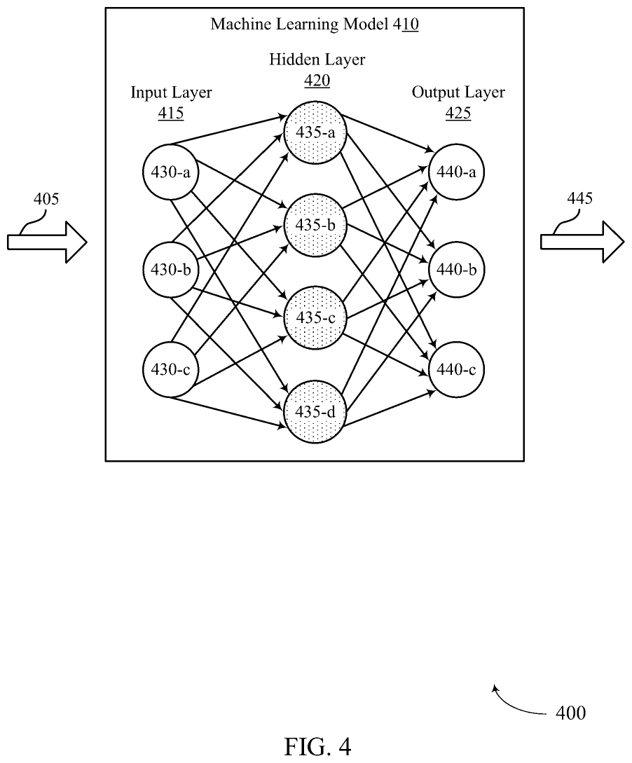

FIG. 4 illustrates an example of a machine learning process 400 that supports predictive beam management mode switching in accordance with one or more aspects of the present disclosure. The machine learning process 400 may be implemented at a wireless device, such as a UE 115 as described herein, including with reference to FIGS. 1-3. The machine learning process 400 may include a machine learning model 410. In some implementations, the wireless device may receive a neural network model from a network entity 105 (as described herein, including with reference to FIGS. 1-4) and implement one or more machine learning models 410 as part of the neural network model to optimize communication processes such as beam management.

As illustrated, the machine learning model 410 may be an example of a neural network, such as a feed forward (FF) or deep feed forward (DFF) neural network, a recurrent neural network (RNN), a long/short term memory (LSTM) neural network, a convolutional neural network (CNN), or any other type of neural network. However, any other machine learning models may be supported by the UE 115. For example, the machine learning model 410 may implement a nearest neighbor algorithm, a linear regression algorithm, a Naïve Bayes algorithm, a random forest algorithm, or any other machine learning model. Further, the machine learning process 400 may involve supervised learning, unsupervised learning, semi-supervised learning, reinforcement learning, or any combination thereof. The machine learning may be performed prior to deployment of a UE 115, while the UE 115 is deployed, during low usage periods of the UE 115 while the UE 115 is deployed, or any combination thereof.

The machine learning model 410 may include an input layer 415, one or more hidden layers 420, and an output layer 425. In a fully connected neural network with one hidden layer 420, each hidden layer node 435 may receive a value from each input layer node 430 as input, where each input is weighted. These neural network weights may be based on a cost function that is revised during training of the machine learning model 410. Similarly, each output layer node 440 may receive a value from each hidden layer node 435 as input, where the inputs are weighted. If post-deployment training (such as online training) is supported at a UE 115, the UE 115 may allocate memory to store errors or gradients for reverse matrix multiplication. These errors or gradients may support updating the machine learning model 410 based on output feedback. Training the machine learning model 410 may support computation of the weights (such as connecting the input layer nodes 430 to the hidden layer nodes 435 and the hidden layer nodes 435 to the output layer nodes 440) to map an input pattern to a desired output outcome. This training may result in a UE-specific machine learning model 410 based on the historic application data and data transfer for a specific UE 115.

The UE 115 may send input values 405 to the machine learning model 410 for processing. In some example, the UE 115 may perform preprocessing according to a sequence of operations received from the network entity 105 on the input values 405 such that the input values 405 may be in a format that is compatible with the machine learning model 410. The input values 405 may be converted into a set of k input layer nodes 430 at the input layer 415. In some implementations, different measurements may be input at different input layer nodes 430 of the input layer 415. Some input layer nodes 430 may be assigned default values (such as values of 0) if the number of input layer nodes 430 exceeds the number of inputs corresponding to the input values 405. As illustrated, the input layer 415 may include three input layer nodes 430-a, 430-b, and 430-c. However, it is to be understood that the input layer 415 may include any number of input layer nodes 430 (such as 20 input layer nodes 430, or some other number of input layer nodes 430).

The machine learning model 410 may convert the input layer 415 to a hidden layer 420 based on a number of input-to-hidden weights between the k input layer nodes 430 and the n hidden layer nodes 435. The machine learning model 410 may include any number of hidden layers 420 as intermediate steps between the input layer 415 and the output layer 425. Additionally, or alternatively, each hidden layer 420 may include any number of nodes. For example, as illustrated, the hidden layer 420 may include four hidden layer nodes 435-a, 435-b, 435-c, and 435-d. However, it is to be understood that the hidden layer 420 may include any number of hidden layer nodes 435 (such as 10 hidden layer nodes 435, or some other number of hidden layer nodes 435). In a fully connected neural network, each node in a layer may be based on each node in the previous layer. For example, the value of hidden layer node 435-a may be based on the values of input layer nodes 430-a, 430-b, and 430-c (such as with different weights applied to each node value).

The machine learning model 410 may determine values for the output layer nodes 440 of the output layer 425 following one or more hidden layers 420. For example, the machine learning model 410 may convert the hidden layer 420 to the output layer 425 based on a number of hidden-to-output weights between the n hidden layer nodes 435 and the m output layer nodes 440. In some implementations, n=m. Each output layer node 440 may correspond to a different output value 445 of the machine learning model 410. As illustrated, the machine learning model 410 may include three output layer nodes 440-a, 440-b, and 440-c, supporting three different output values associate with blocking prediction. However, it is to be understood that the output layer 425 may include any number of output layer nodes 440 (such as 10 output layer nodes 440, or some other number of output layer nodes 440).

In some implementations, a UE 115 may utilize a neural network model based on the machine learning model 410, which may be used to perform beam management prediction procedures, as described with reference to FIGS. 2 and 3. For example, a UE 115 may utilize the neural network model to predict spatial domain, time domain, frequency domain communication characteristics, or a combination thereof, and report such communication characteristics to a network entity 105.

The UE 115 may use previous measurements of a set of resources (e.g., CSI-RS or synchronization signal block (SSB) resources) as input values 405 according to a beam measurement mode and obtain predicted time domain characteristics as output values 445 without receiving another set of resources. The UE 115 may also use measurements of a set of resources or a number of ports (e.g., CSI-RS/SSB resources or CSI-RS ports) as input values 405 according to a beam measurement mode and obtain predicted spatial domain characteristics for resources or ports not received by the UE 115 as output values 445. Similarly, the UE 115 may use previous measurements of a resources set (e.g., a CSI-RS or SSB resource set) associated with a BWP or serving cell as input values 405 to obtain frequency domain channel characteristics of a resource set not received by the UE 115 as output values 445. In some cases, the UE 115 may further be configured with resources sets (e.g., NZP-CSI-RS resource sets) that mimic a resource set (e.g., a ZP-CSI-RS resource set) for which the UE 115 is configured to predict channel characteristics. The UE 115 may further be configured with a report (e.g., a CSI report) whose report quantity includes predicted values (e.g., CSI-RS resource indicator RSRP) for the resource set for use with the machine learning model 410. By utilizing the machine learning model 410, the UE 115 may predict channel characteristics without a network entity 105 having to transmit the corresponding resources, ports, or resource sets, thereby reducing signaling overhead and power consumption, among other benefits.

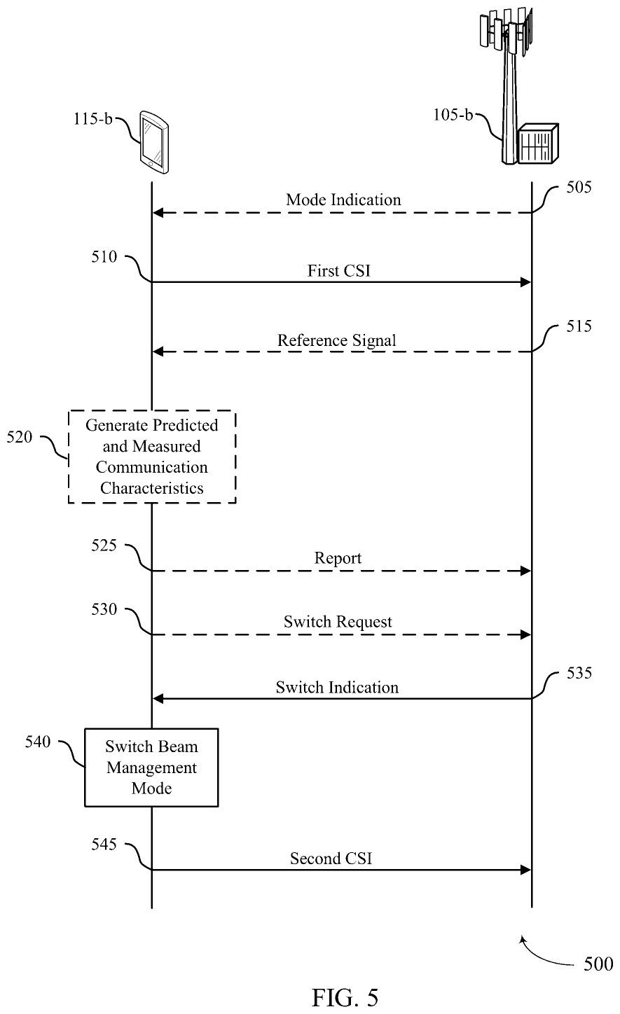

FIG. 5 illustrates an example of a process flow 500 that supports predictive beam management mode switching in accordance with one or more aspects of the present disclosure. The process flow may be implemented by aspects of the wireless communications system 100 and 200, the beam management mode diagram 300, and the machine learning process 400. For example, the process flow 500 may illustrate communication between a UE 115-b and a network entity 105-b, which may be examples of corresponding devices described herein, including with reference to FIGS. 1 through 4.

In the following description of the process flow 500, the operations may be performed (for example, reported or provided) in a different order than the order shown. Specific operations also may be left out of the process flow 500, or other operations may be added to the process flow 500. Further, although some operations or signaling may be shown to occur at different times for discussion purposes, these operations may actually occur at the same time.

At 505, the UE 115-b may receive, from the network entity 105-b, a mode indication (e.g., a mode indication 220). In some examples, the mode indication may contain an ID ((e.g., a CSI report setting ID, a resource setting ID, a BWP-ID, a ServCell-ID) associated with a first beam management mode to signal the UE 115-b to operate according to the first beam management mode for performing beam management and reporting. As such, the UE 115-b may determine CSI including spatial domain, time domain, and/or frequency domain channel characteristics in accordance with the first beam management mode. For example, the first beam management mode may be a beam management mode for predicting CSI using a first machine learning model associated with the first beam management mode.

At 510, the UE 115-b may transmit first CSI (e.g., CSI 225) generated (e.g., predicted) in accordance with the first beam management mode to the network entity 105-b. For example, the UE 115-b may transmit a first CSI report to the network entity 105-b to support beam management for communications between the UE 115-b and the network entity 105-b.

At 515, the network entity 105-b may transmit one or more reference signals (e.g., reference signals 240) to the UE 115-b for measurement by the UE 115-b. In some examples, the network entity 105-b may transmit an activation message (e.g., an activation message 235) to the UE 115-b prior to transmitting the one or more reference signals to indicate transmission of the one or more reference signals. In some examples, the UE 115-b may transmit a request (e.g., a reference signal request 230) for the network entity 105-b to transmit the one or more reference signals, and the network entity 105-b may transmit the one or more reference signals in response to the request.

The one or more reference signals may be associated with a reference signal resource set for which CSI associated with the reference signal resource set is configured to be predicted by the UE 115-b in accordance with the first beam management mode. For example, the one or more reference signals may be transmitted during a time instance or a slot for which CSI is configured to be predicted in accordance with the first beam management mode. Additionally, or alternatively, the one or more reference signals may be transmitted over a first set of CSI-RS or SSB resources (e.g., associated with a first BWP or serving cell) for which CSI is configured to be predicted

At 520, the UE 115-b may generate predicted communication characteristics in accordance with the first beam management mode and measured communication characteristics based on the one or more reference signals. In some examples, the UE 115-b may determine a difference (e.g., error) between the predicted and measured communication characteristics, for example, by comparing the predicted communication characteristics to the measured communication characteristics. In some cases, the UE 115-b may determine to request a beam management mode switch based on, for example, the difference between the predicted and measured communication characteristics satisfying a threshold.

In some examples, the predicted communication characteristics may include a predicted top K resources of a channel for communication between the UE 115-b and the network entity 105-b, such as in terms of their L1-RSRP and/or L1-SINR values relative to other resources of the channel.

At 525, the UE 115-b may send a report (e.g., a report 245) to the network entity 105-b. The report may contain the predicted communication characteristics, the measured communication characteristics, the difference between the predicted and measured communication characteristics, or any combination thereof. In some cases, the UE 115-b may have been instructed to send the report by the network entity 105-b.

At 530, the UE 115-b may send a switch request (e.g., a switch request 250) to the network entity 105-b. The switch request may contain an ID corresponding to a second beam management mode. The UE 115-b may determine to send a switch request in response to, for example, a change in operating conditions, the difference between the predicted and measured communication characteristics satisfying the threshold, or any combination thereof. In some cases, the switch request may be together with the report (e.g., in a same message).

At 535, the network entity 105-b may send a switch indication (e.g., a switch response 255) to the UE 115-b containing the ID associated with the second beam management mode to signal the UE 115-b to switch to using the second beam management mode for performing beam management and reporting. The network entity 105-b may determine to send the switch indication based on the received report or the switch request.

At 540, the UE 115-b may switch to using the second beam management mode for performing beam management and reporting based on the received switch indication. As such, the UE 115-b may determine CSI including spatial domain, time domain, and/or frequency domain channel characteristics according to the second beam management mode. In some examples, the second beam management mode may be for predicting CSI using a second machine learning model associated with the second beam management mode. In some examples, the second beam management mode may be for generating CSI based on reference signal measurements.

At 545, the UE 115-b may transmit a second CSI determined in accordance with the second beam management mode to the network entity 105-b. For example, the UE 115-b may transmit a second CSI report to the network entity 105-b to support beam management for communications between the UE 115-b and the network entity 105-b.

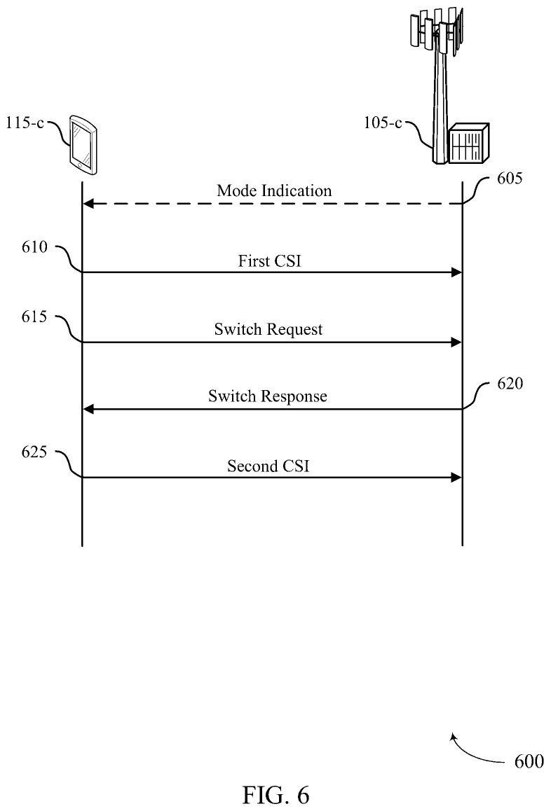

FIG. 6 illustrates an example of a process flow 600 that supports predictive beam management mode switching in accordance with one or more aspects of the present disclosure. The process flow may be implemented by aspects of the wireless communications system 100 and 200, the beam management mode diagram 300, and the machine learning process 400. For example, the process flow 600 may illustrate communication between a UE 115-c and a network entity 105-c, which may be examples of corresponding devices described herein, including with reference to FIGS. 1 through 4.

In the following description of the process flow 600, the operations may be performed (for example, reported or provided) in a different order than the order shown. Specific operations also may be left out of the process flow 600, or other operations may be added to the process flow 600. Further, although some operations or signaling may be shown to occur at different times for discussion purposes, these operations may actually occur at the same time.

At 605, the UE 115-c may receive, from the network entity 105-c, a mode indication (e.g., a mode indication 220). In some examples, the mode indication may contain an ID associated with a first beam management mode to signal the UE 115-c to operate according to a first beam management mode for performing beam management and reporting. As such, the UE 115-c may determine CSI including spatial domain, time domain, and/or frequency domain channel characteristics in accordance with the first beam management mode. For example, the first beam management mode may be a beam management mode for predicting CSI using a first machine learning model associated with the first beam management mode.

At 610, the UE 115-c may transmit first CSI (e.g., CSI 225) generated (e.g., predicted) in accordance with the first beam management mode to the network entity 105-c.

At 615, the UE 115-c may send a switch request (e.g., a switch request 250) to the network entity 105-c. The switch request may contain an ID corresponding to a second beam management mode. The UE 115-b may determine to send the switch request based on the first CSI. For example, the UE 115-b may determine that since transmission of the first CSI, a change in operating conditions, a difference between predicted and measured communication characteristics satisfies a threshold, or any combination thereof, has occurred. In some examples, the switch request may include an indication of the K resources of a channel for communication between the UE 115-c and the network entity 105-c that are predicted to have the highest communication characteristics, such as in terms of their L1-RSRP and/or L1-SINR values, relative to other (e.g., remaining) resources of the channel.

At 620, the network entity 105-c may send a switch response (e.g., a switch response 255) to the UE 115-c. The switch response may contain an ID associated with the second beam management mode to signal the UE 115-b to switch to using the second beam management mode for performing beam management and reporting. Alternatively, the switch indication may deny the switch request by the UE 115-c.

At 625, the UE 115-c may transmit second CSI in accordance with an beam management mode indicated by the switch response. For example, if the network entity 105-c indicated the second beam management mode (e.g., accepted the switch request), the UE 115-c may transmit the second CSI generated according to the second beam management mode. Alternatively, if the network entity 105-c denied the switch request, the UE 115-c may transmit the second CSI generated according to the first beam management mode.

FIG. 7 shows a block diagram 700 of a device 705 that supports predictive beam management mode switching in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to predictive beam management mode switching). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to predictive beam management mode switching). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of predictive beam management mode switching as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled (e.g., operatively, communicatively, functionally, or electrically) to the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software) executed by a processor. If implemented in code executed by a processor, the functions of the communications manager 720, the receiver 710, the transmitter 715, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. For example, the communications manager 720 may be configured as or otherwise support a means for transmitting first CSI associated with a channel for the UE, the first CSI generated in accordance with a first beam management mode associated with prediction of the first CSI based on a machine learning model associated with the first beam management mode. The communications manager 720 may be configured as or otherwise support a means for receiving an indication to switch from the first beam management mode to a second beam management mode associated with generation of second CSI associated with the channel for the UE. The communications manager 720 may be configured as or otherwise support a means for switching from the first beam management mode to the second beam management mode based on the indication to switch to the second beam management mode. The communications manager 720 may be configured as or otherwise support a means for transmitting the second CSI associated with the channel for the UE, the second CSI generated in accordance with the second beam management mode based on the switching.

Additionally, or alternatively, the communications manager 720 may support wireless communications at a UE in accordance with examples as disclosed herein. For example, the communications manager 720 may be configured as or otherwise support a means for transmitting first CSI associated with a channel for the UE, the first CSI generated in accordance with a first beam management mode associated with prediction of the first CSI based on a machine learning model associated with the first beam management mode. The communications manager 720 may be configured as or otherwise support a means for transmitting a request to switch from the first beam management mode to a second beam management mode associated with generation of second CSI associated with the channel for the UE based on the first CSI.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for improved machine learning-based beam management, increased beam selection and CSI reporting accuracy, and reduced beam failure, leading to reduced overhead, reduced processing and power consumption and more efficient utilization of communication resources, among other benefits.

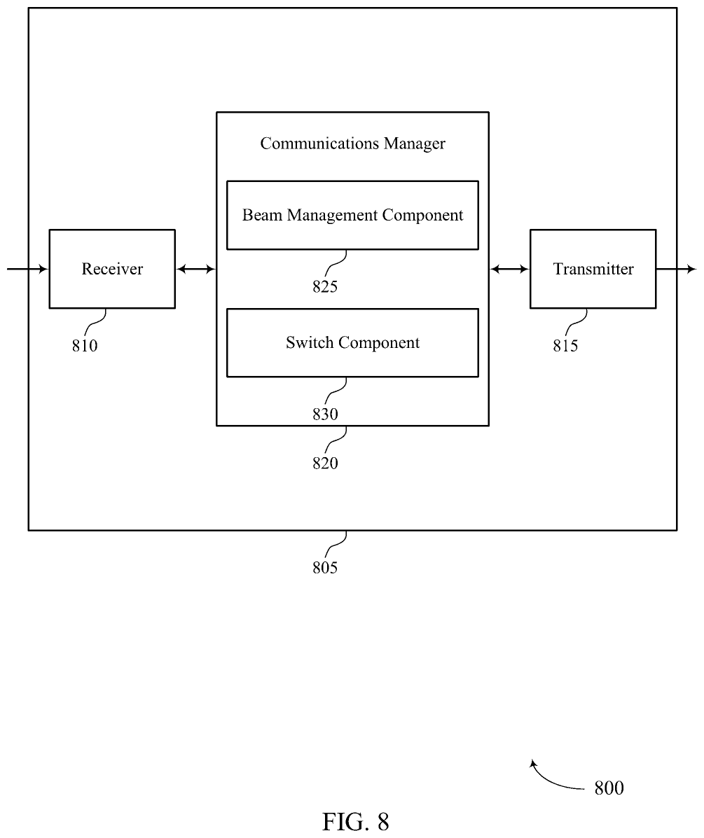

FIG. 8 shows a block diagram 800 of a device 805 that supports predictive beam management mode switching in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to predictive beam management mode switching). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to predictive beam management mode switching). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of predictive beam management mode switching as described herein. For example, the communications manager 820 may include a beam management component 825 a switch component 830, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a UE in accordance with examples as disclosed herein. The beam management component 825 may be configured as or otherwise support a means for transmitting first CSI associated with a channel for the UE, the first CSI generated in accordance with a first beam management mode associated with prediction of the first CSI based on a machine learning model associated with the first beam management mode. The switch component 830 may be configured as or otherwise support a means for receiving an indication to switch from the first beam management mode to a second beam management mode associated with generation of second CSI associated with the channel for the UE. The switch component 830 may be configured as or otherwise support a means for switching from the first beam management mode to the second beam management mode based on the indication to switch to the second beam management mode. The beam management component 825 may be configured as or otherwise support a means for transmitting the second CSI associated with the channel for the UE, the second CSI generated in accordance with the second beam management mode based on the switching.

Additionally, or alternatively, the communications manager 820 may support wireless communications at a UE in accordance with examples as disclosed herein. The beam management component 825 may be configured as or otherwise support a means for transmitting first CSI associated with a channel for the UE, the first CSI generated in accordance with a first beam management mode associated with prediction of the first CSI based on a machine learning model associated with the first beam management mode. The switch component 830 may be configured as or otherwise support a means for transmitting a request to switch from the first beam management mode to a second beam management mode associated with generation of second CSI associated with the channel for the UE based on the first CSI.

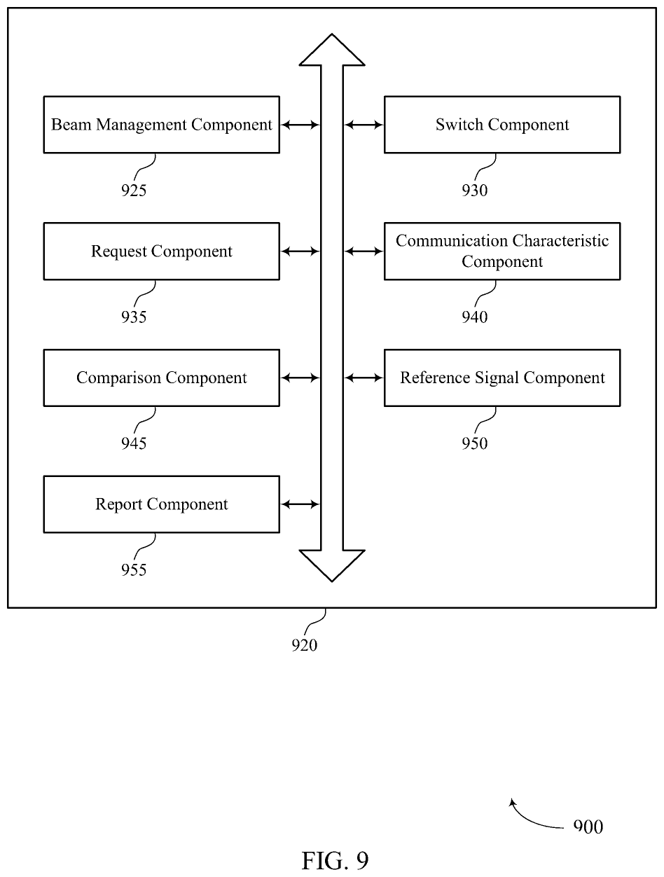

FIG. 9 shows a block diagram 900 of a communications manager 920 that supports predictive beam management mode switching in accordance with one or more aspects of the present disclosure. The communications manager 920 may be an example of aspects of a communications manager 720, a communications manager 820, or both, as described herein. The communications manager 920, or various components thereof, may be an example of means for performing various aspects of predictive beam management mode switching as described herein. For example, the communications manager 920 may include a beam management component 925, a switch component 930, a request component 935, a communication characteristic component 940, a comparison component 945, a reference signal component 950, a report component 955, or any combination thereof. Each of these components may communicate, directly or indirectly, with one another (e.g., via one or more buses).

The communications manager 920 may support wireless communications at a UE in accordance with examples as disclosed herein. The beam management component 925 may be configured as or otherwise support a means for transmitting first CSI associated with a channel for the UE, the first CSI generated in accordance with a first beam management mode associated with prediction of the first CSI based on a machine learning model associated with the first beam management mode. The switch component 930 may be configured as or otherwise support a means for receiving an indication to switch from the first beam management mode to a second beam management mode associated with generation of second CSI associated with the channel for the UE. In some examples, the switch component 930 may be configured as or otherwise support a means for switching from the first beam management mode to the second beam management mode based on the indication to switch to the second beam management mode. In some examples, the beam management component 925 may be configured as or otherwise support a means for transmitting the second CSI associated with the channel for the UE, the second CSI generated in accordance with the second beam management mode based on the switching.

In some examples, the request component 935 may be configured as or otherwise support a means for transmitting a request to switch to the second beam management mode, where the indication to switch to the second beam management mode is based on the request.

In some examples, to support transmitting the request to switch to the second beam management mode, the request component 935 may be configured as or otherwise support a means for transmitting the request based on a threshold change between a first output of the machine learning model and a second output of the machine learning model, a threshold change between a measurement of a first reference signal received over the channel for the UE and a measurement of a second reference signal received over the channel for the UE, or a combination thereof.

In some examples, the communication characteristic component 940 may be configured as or otherwise support a means associated with generation of, using the machine learning model and in accordance with the first beam management mode, a predicted set of communication characteristics of the channel for the UE, the predicted set of communication characteristics indicating CSI in accordance with the first beam management mode. In some examples, the communication characteristic component 940 may be configured as or otherwise support a means associated with generation of a measured set of communication characteristics of the channel for the UE corresponding to the predicted set of communication characteristics based on a reference signal received over the channel for the UE, where the indication to switch to the second beam management mode is based on a difference between the predicted set of communication characteristics and the measured set of communication characteristics satisfying a threshold.

In some examples, the predicted set of communication characteristics and the measured set of communication characteristics each include a respective set of spatial domain communication characteristics, a respective set of time domain communication characteristics, a respective set of frequency domain communication characteristics, or a combination thereof.

In some examples, the reference signal component 950 may be configured as or otherwise support a means for transmitting a request for transmission of the reference signal. In some examples, the reference signal component 950 may be configured as or otherwise support a means for receiving the reference signal over the channel for the UE in response to the request.

In some examples, the reference signal component 950 may be configured as or otherwise support a means for receiving an activation message indicating transmission of the reference signal. In some examples, the reference signal component 950 may be configured as or otherwise support a means for receiving the reference signal over the channel for the UE in response to the activation message.

In some examples, the report component 955 may be configured as or otherwise support a means for transmitting a report including the predicted set of communication characteristics and the measured set of communication characteristics or including an indication of the difference between the predicted set of communication characteristics and the measured set of communication characteristics.

In some examples, the indication to switch to the second beam management mode is received in response to the report based on the difference between the predicted set of communication characteristics and the measured set of communication characteristics satisfying the threshold.

In some examples, the comparison component 945 may be configured as or otherwise support a means for transmitting a request to switch to the second beam management mode based on a comparison of the predicted set of communication characteristics and the measured set of communication characteristics to determine the difference between the predicted set of communication characteristics and the measured set of communication characteristics, where the indication to switch to the second beam management mode is received in response to the request.

In some examples, the reference signal is associated with a time instance for which CSI associated with the time instance is configured to be predicted in accordance with the first beam management mode.

In some examples, the reference signal is associated with a reference signal resource set for which CSI associated with the reference signal resource set is configured to be predicted in accordance with the first beam management mode.

In some examples, the communication characteristic component 940 may be configured as or otherwise support generating, using the machine learning model and in accordance with the first beam management mode, a second indication of a set of resources of the channel predicted to have higher communication characteristics relative to other resources of the channel, the communication characteristics including respective RSRPs associated with the set of resources, respective SINRs associated with the set of resources, or a combination thereof. In some examples, the report component 955 may be configured as or otherwise support a means for transmitting a report including the second indication of the set of resources, where the indication to switch to the second beam management mode is based on the report.

In some examples, the report includes a request to switch to the second beam management mode, where the indication to switch to the second beam management mode is based on the request.

In some examples, the second beam management mode is associated with prediction of the second CSI based on a second machine learning model associated with the second beam management mode.

In some examples, the second beam management mode is associated with generation of the second CSI based on a measurement of a reference signal received over the channel for the UE.

In some examples, the indication to switch to the second beam management mode includes an indication to deactivate a first type of CSI report associated with the first beam management mode or a first reference signal resource set associated with the first beam management mode and an indication to activate a second type of CSI report associated with the second beam management mode or a second reference signal resource set associated with the second beam management mode.

In some examples, the beam management component 925 may be configured as or otherwise support a means for receiving signaling that indicates the machine learning model associated with the first beam management mode, where the first CSI is generated using the machine learning model.

Additionally, or alternatively, the communications manager 920 may support wireless communications at a UE in accordance with examples as disclosed herein. In some examples, the beam management component 925 may be configured as or otherwise support a means for transmitting first CSI associated with a channel for the UE, the first CSI generated in accordance with a first beam management mode associated with prediction of the first CSI based on a machine learning model associated with the first beam management mode. In some examples, the switch component 930 may be configured as or otherwise support a means for transmitting a request to switch from the first beam management mode to a second beam management mode associated with generation of second CSI associated with the channel for the UE based on the first CSI.

In some examples, the switch component 930 may be configured as or otherwise support a means for switching from the first beam management mode to the second beam management mode. In some examples, the beam management component 925 may be configured as or otherwise support a means for transmitting the second CSI associated with the channel for the UE, the second CSI generated in accordance with the second beam management mode based on the switching.

In some examples, the switch component 930 may be configured as or otherwise support a means for receiving an indication to switch from the first beam management mode to the second beam management mode based on the request, where the switching is based on the indication.

In some examples, the communication characteristic component 940 may be configured as or otherwise support a means associated with generation of, using the machine learning model and in accordance with the first beam management mode, a predicted set of communication characteristics of the channel for the UE, the predicted set of communication characteristics indicating CSI in accordance with the first beam management mode. In some examples, the communication characteristic component 940 may be configured as or otherwise support a means associated with generation of a measured set of communication characteristics of the channel for the UE corresponding to the predicted set of communication characteristics based on a reference signal received over the channel for the UE, where the indication to switch to the second beam management mode is based on a difference between the predicted set of communication characteristics and the measured set of communication characteristics satisfying a threshold.

In some examples, the predicted set of communication characteristics and the measured set of communication characteristics each include a respective set of spatial domain communication characteristics, a respective set of time domain communication characteristics, a respective set of frequency domain communication characteristics, or a combination thereof.

In some examples, the reference signal component 950 may be configured as or otherwise support a means for transmitting a request for transmission of the reference signal. In some examples, the reference signal component 950 may be configured as or otherwise support a means for receiving the reference signal over the channel for the UE in response to the request for transmission of the reference signal.

In some examples, the reference signal component 950 may be configured as or otherwise support a means for receiving an activation message indicating transmission of the reference signal. In some examples, the reference signal component 950 may be configured as or otherwise support a means for receiving the reference signal over the channel for the UE in response to the activation message.

In some examples, the report component 955 may be configured as or otherwise support a means for transmitting a report including the predicted set of communication characteristics and the measured set of communication characteristics or including an indication of the difference between the predicted set of communication characteristics and the measured set of communication characteristics.

In some examples, the switch component 930 may be configured as or otherwise support a means for receiving an indication to switch from the first beam management mode to the second beam management mode, where the indication to switch is received in response to the report based on the difference between the predicted set of communication characteristics and the measured set of communication characteristics satisfying the threshold.

In some examples, transmitting the request is based on a comparison of the predicted set of communication characteristics and the measured set of communication characteristics to determine the difference between the predicted set of communication characteristics and the measured set of communication characteristics.

In some examples, the reference signal is associated with a time instance for which CSI associated with the time instance is configured to be predicted in accordance with the first beam management mode.

In some examples, the reference signal is associated with a reference signal resource set for which CSI associated with the reference signal resource set is configured to be predicted in accordance with the first beam management mode.

In some examples, the indication to switch to the second beam management mode includes an indication to deactivate a first type of CSI report associated with the first beam management mode or a first reference signal resource set associated with the first beam management mode and an indication to activate a second type of CSI report associated with the second beam management mode or a second reference signal resource set associated with the second beam management mode.

In some examples, the communication characteristic component 940 may be configured as or otherwise support a means for generating, using the machine learning model and in accordance with the first beam management mode, an indication of a set of resources of the channel that are predicted to have higher communication characteristics relative to other resources of the channel, the communication characteristics including respective RSRPs associated with the set of resources, respective SINRs associated with the set of resources, or a combination thereof, where the request to switch to the second beam management mode includes the indication of the set of resources.

In some examples, the switch component 930 may be configured as or otherwise support a means for receiving a message denying the switch from the first beam management mode to the second beam management mode based on the request.

In some examples, transmitting the request is based on a threshold change between a first output of the machine learning model and a second output of the machine learning model, a threshold change between a measurement of a first reference signal received over the channel for the UE and a measurement of a second reference signal received over the channel for the UE, or a combination thereof.

In some examples, the second beam management mode is associated with prediction of the second CSI based on a second machine learning model associated with the second beam management mode.

In some examples, the second beam management mode is associated with generation of the second CSI based on a measurement of a reference signal received over the channel for the UE.

In some examples, the beam management component 925 may be configured as or otherwise support a means for receiving signaling that indicates the machine learning model associated with the first beam management mode, where the first CSI is generated using the machine learning model.

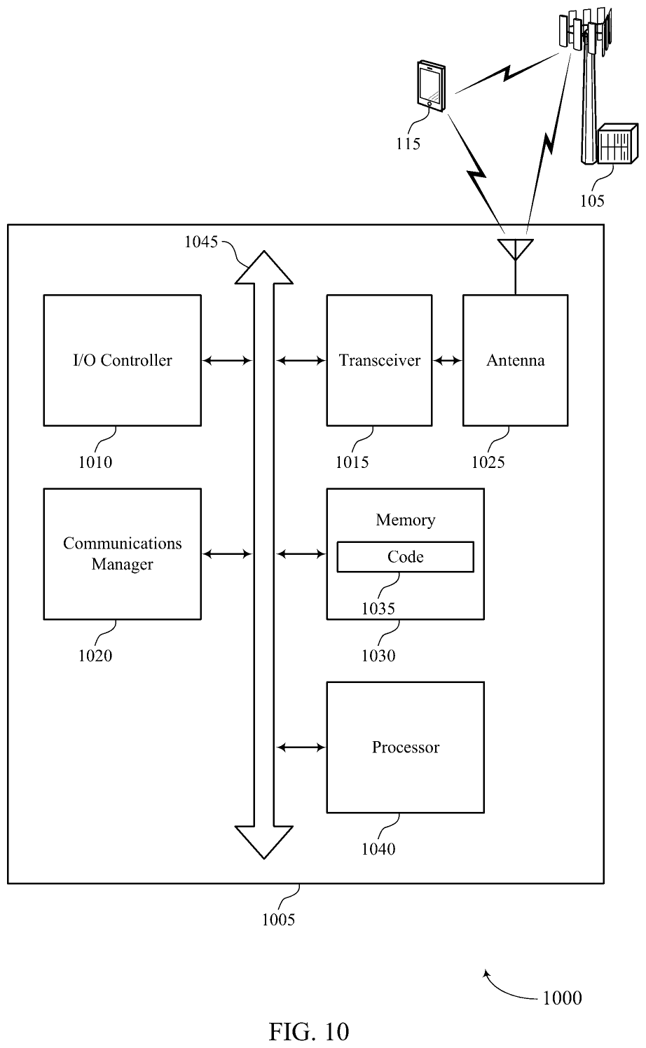

FIG. 10 shows a diagram of a system 1000 including a device 1005 that supports predictive beam management mode switching in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting predictive beam management mode switching). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communications at a UE in accordance with examples as disclosed herein. For example, the communications manager 1020 may be configured as or otherwise support a means for transmitting first CSI associated with a channel for the UE, the first CSI generated in accordance with a first beam management mode associated with prediction of the first CSI based on a machine learning model associated with the first beam management mode. The communications manager 1020 may be configured as or otherwise support a means for receiving an indication to switch from the first beam management mode to a second beam management mode associated with generation of second CSI associated with the channel for the UE. The communications manager 1020 may be configured as or otherwise support a means for switching from the first beam management mode to the second beam management mode based on the indication to switch to the second beam management mode. The communications manager 1020 may be configured as or otherwise support a means for transmitting the second CSI associated with the channel for the UE, the second CSI generated in accordance with the second beam management mode based on the switching.

Additionally, or alternatively, the communications manager 1020 may support wireless communications at a UE in accordance with examples as disclosed herein. For example, the communications manager 1020 may be configured as or otherwise support a means for transmitting first CSI associated with a channel for the UE, the first CSI generated in accordance with a first beam management mode associated with prediction of the first CSI based on a machine learning model associated with the first beam management mode. The communications manager 1020 may be configured as or otherwise support a means for transmitting a request to switch from the first beam management mode to a second beam management mode associated with generation of second CSI associated with the channel for the UE based on the first CSI.

By including or configuring the communications manager 1020 in accordance with examples as described herein, the device 1005 may support techniques for improved machine learning-based beam management, increased beam selection accuracy, increased CSI reporting accuracy, reduced frequency of beam failure, reduced processing and power consumption, more efficient utilization of communication resources, improved coordination between devices, improved utilization of processing capability, and an enhanced user experience, among other benefits.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of predictive beam management mode switching as described herein, or the processor 1040 and the memory 1030 may be otherwise configured to perform or support such operations.

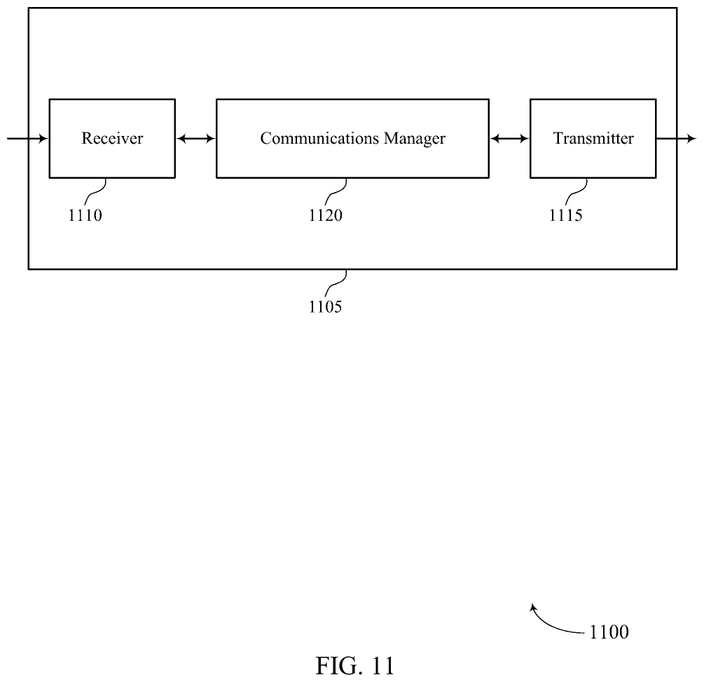

FIG. 11 shows a block diagram 1100 of a device 1105 that supports predictive beam management mode switching in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of predictive beam management mode switching as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled (e.g., operatively, communicatively, functionally, or electrically) to the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software) executed by a processor. If implemented in code executed by a processor, the functions of the communications manager 1120, the receiver 1110, the transmitter 1115, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. For example, the communications manager 1120 may be configured as or otherwise support a means for obtaining first CSI associated with a channel for communicating with a UE, the first CSI predicted in accordance with a first beam management mode of the UE based on a machine learning model associated with the first beam management mode. The communications manager 1120 may be configured as or otherwise support a means for outputting an indication for the UE to switch from the first beam management mode to a second beam management mode associated with generation of second CSI associated with the channel. The communications manager 1120 may be configured as or otherwise support a means for obtaining the second CSI associated with the channel in accordance with the second beam management mode based on the indication.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for improved machine learning-based beam management, increased beam selection and CSI reporting accuracy, and reduced beam failure, leading to reduced processing, reduced power consumption, and more efficient utilization of communication resources, among other benefits.

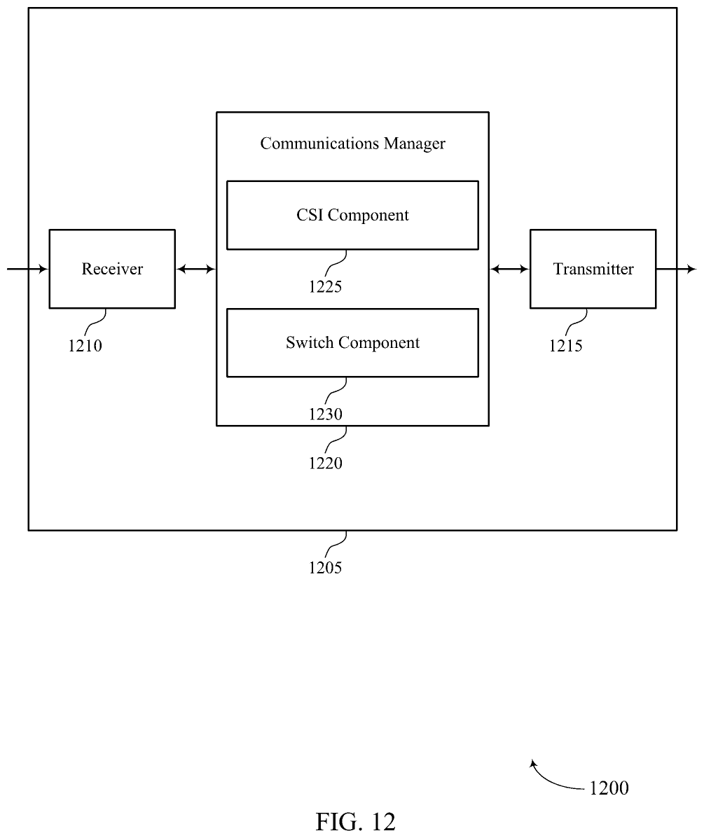

FIG. 12 shows a block diagram 1200 of a device 1205 that supports predictive beam management mode switching in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of predictive beam management mode switching as described herein. For example, the communications manager 1220 may include a CSI component 1225 a switch component 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a network entity in accordance with examples as disclosed herein. The CSI component 1225 may be configured as or otherwise support a means for obtaining first CSI associated with a channel for communicating with a UE, the first CSI predicted in accordance with a first beam management mode of the UE based on a machine learning model associated with the first beam management mode. The switch component 1230 may be configured as or otherwise support a means for outputting an indication for the UE to switch from the first beam management mode to a second beam management mode associated with generation of second CSI associated with the channel. The CSI component 1225 may be configured as or otherwise support a means for obtaining the second CSI associated with the channel in accordance with the second beam management mode based on the indication.

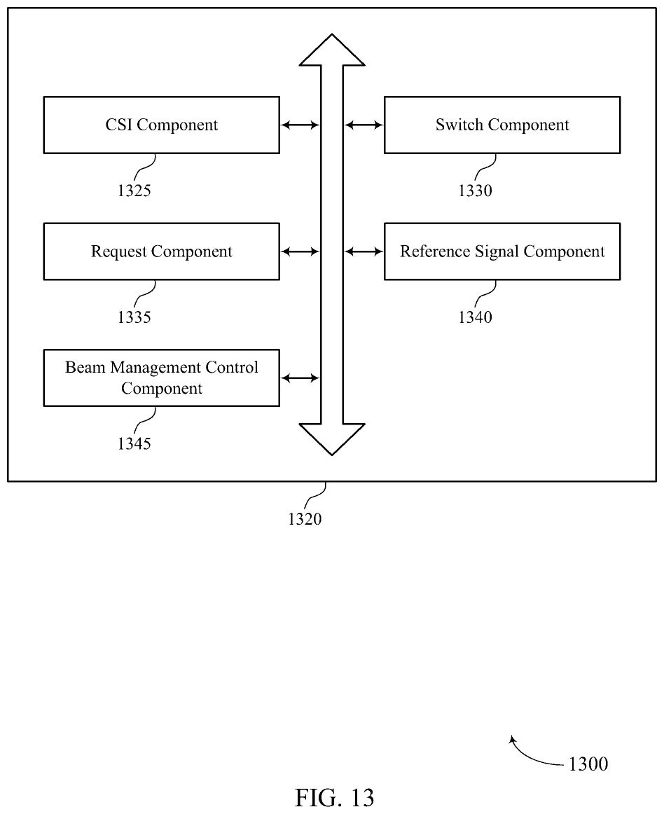

FIG. 13 shows a block diagram 1300 of a communications manager 1320 that supports predictive beam management mode switching in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of predictive beam management mode switching as described herein. For example, the communications manager 1320 may include a CSI component 1325, a switch component 1330, a request component 1335, a reference signal component 1340, a beam management control component 1345, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications at a network entity in accordance with examples as disclosed herein. The CSI component 1325 may be configured as or otherwise support a means for obtaining first CSI associated with a channel for communicating with a UE, the first CSI predicted in accordance with a first beam management mode of the UE based on a machine learning model associated with the first beam management mode. The switch component 1330 may be configured as or otherwise support a means for outputting an indication for the UE to switch from the first beam management mode to a second beam management mode associated with generation of second CSI associated with the channel. In some examples, the CSI component 1325 may be configured as or otherwise support a means for obtaining the second CSI associated with the channel in accordance with the second beam management mode based on the indication.

In some examples, the request component 1335 may be configured as or otherwise support a means for obtaining a request to indicate for the UE to switch to the second beam management mode, where the indication to switch to the second beam management mode is based on the request.

In some examples, the reference signal component 1340 may be configured as or otherwise support a means for outputting a reference signal over the channel, the reference signal associated with an instance for which CSI associated with the instance is configured to be predicted in accordance with the first beam management mode, where the indication for the UE to switch to the second beam management mode is based on a difference between measured CSI corresponding to the reference signal and predicted CSI corresponding to the reference signal satisfying a threshold.

In some examples, the reference signal component 1340 may be configured as or otherwise support a means for obtaining a request for transmission of the reference signal, where the reference signal is output in response to the request.

In some examples, the reference signal component 1340 may be configured as or otherwise support a means for outputting an indication of transmission of the reference signal, where the reference signal is output after the indication of the transmission of the reference signal is output.

In some examples, the CSI component 1325 may be configured as or otherwise support a means for obtaining a report including the measured CSI and the predicted CSI or an indication of the difference between the measured CSI and the predicted CSI.

In some examples, the indication for the UE to switch to the second beam management mode is output in response to the report based on the difference between the measured CSI and the predicted CSI satisfying the threshold.

In some examples, the reference signal is associated with a time instance for which CSI associated with the time instance is configured to be predicted in accordance with the first beam management mode.

In some examples, the reference signal is associated with a reference signal resource set for which CSI associated with the reference signal resource set is configured to be predicted in accordance with the first beam management mode.

In some examples, the beam management control component 1345 may be configured as or otherwise support a means for obtaining a report including a second indication of a set of resources of the channel predicted to have higher communication characteristics relative to other resources of the channel, the communication characteristics including respective RSRPs associated with the set of resources, respective SINRs associated with the set of resources, or a combination thereof.

In some examples, the second beam management mode is associated with prediction of the second CSI based on a second machine learning model associated with the second beam management mode.

In some examples, the second beam management mode is associated with generation of the second CSI based on a measurement of a reference signal received over the channel for the UE.

In some examples, the indication to switch to the second beam management mode includes an indication to deactivate a first type of CSI report associated with the first beam management mode or a first reference signal resource set associated with the first beam management mode and an indication to activate a second type of CSI report associated with the second beam management mode or a second reference signal resource set associated with the second beam management mode.

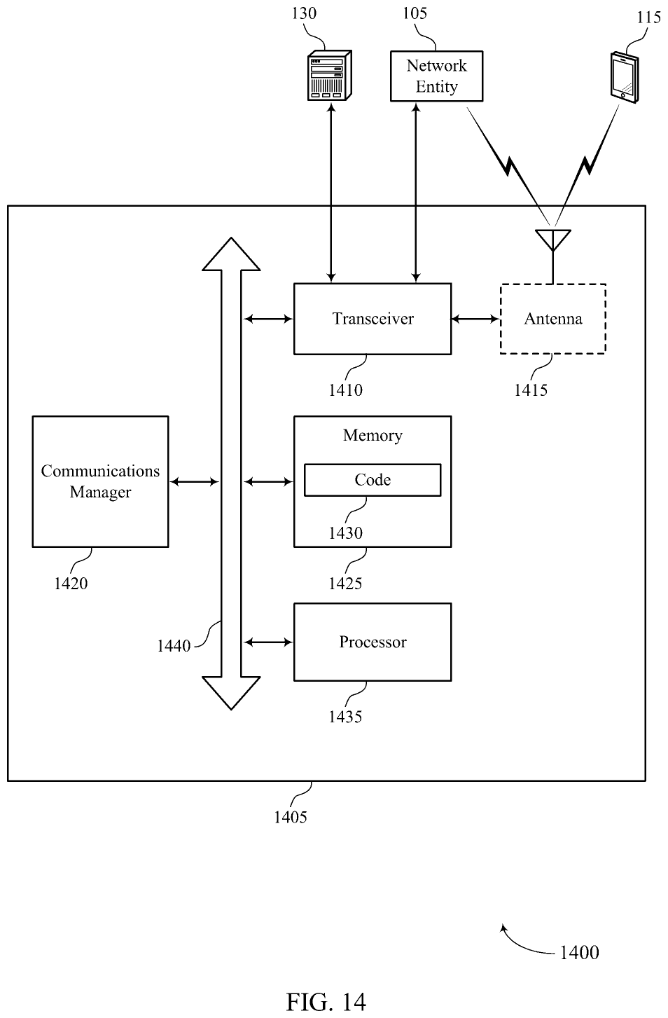

FIG. 14 shows a diagram of a system 1400 including a device 1405 that supports predictive beam management mode switching in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. The transceiver 1410, or the transceiver 1410 and one or more antennas 1415 or wired interfaces, where applicable, may be an example of a transmitter 1115, a transmitter 1215, a receiver 1110, a receiver 1210, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting predictive beam management mode switching). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communications at a network entity in accordance with examples as disclosed herein. For example, the communications manager 1420 may be configured as or otherwise support a means for obtaining first CSI associated with a channel for communicating with a UE, the first CSI predicted in accordance with a first beam management mode of the UE based on a machine learning model associated with the first beam management mode. The communications manager 1420 may be configured as or otherwise support a means for outputting an indication for the UE to switch from the first beam management mode to a second beam management mode associated with generation of second CSI associated with the channel. The communications manager 1420 may be configured as or otherwise support a means for obtaining the second CSI associated with the channel in accordance with the second beam management mode based on the indication.

By including or configuring the communications manager 1420 in accordance with examples as described herein, the device 1405 may support techniques for may support techniques for improved machine learning-based beam management, increased beam selection accuracy, increased CSI reporting accuracy, reduced frequency of beam failure, reduced processing, reduced power consumption, more efficient utilization of communication resources, improved coordination between devices, improved utilization of processing capability, and an enhanced user experience, among other benefits.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the processor 1435, the memory 1425, the code 1430, the transceiver 1410, or any combination thereof. For example, the code 1430 may include instructions executable by the processor 1435 to cause the device 1405 to perform various aspects of predictive beam management mode switching as described herein, or the processor 1435 and the memory 1425 may be otherwise configured to perform or support such operations.

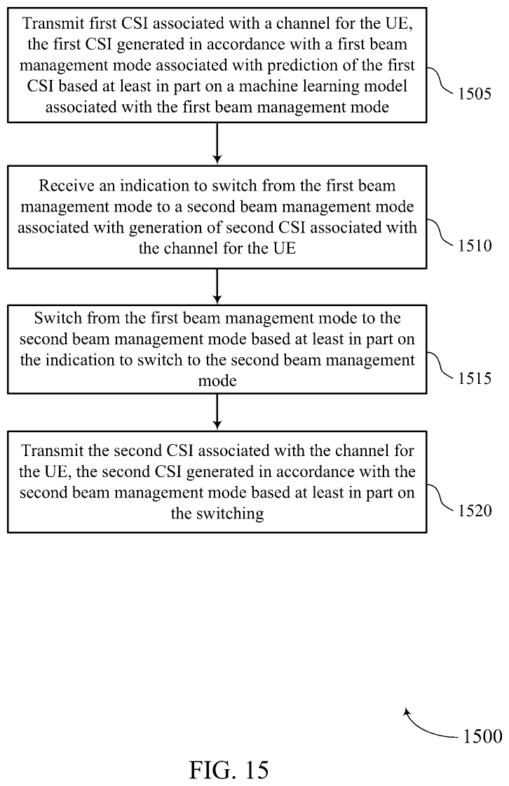

FIG. 15 shows a flowchart illustrating a method 1500 that supports predictive beam management mode switching in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include transmitting first CSI associated with a channel for the UE, the first CSI generated in accordance with a first beam management mode associated with prediction of the first CSI based at least in part on a machine learning model associated with the first beam management mode. The operations of 1505 may be performed in accordance with examples as disclosed herein. In some examples, aspects of the operations of 1505 may be performed by a beam management component 925 as described with reference to FIG. 9.

At 1510, the method may include receiving an indication to switch from the first beam management mode to a second beam management mode associated with generation of second CSI associated with the channel for the UE. The operations of 1510 may be performed in accordance with examples as disclosed herein. In some examples, aspects of the operations of 1510 may be performed by a switch component 930 as described with reference to FIG. 9.

At 1515, the method may include switching from the first beam management mode to the second beam management mode based at least in part on the indication to switch to the second beam management mode. The operations of 1515 may be performed in accordance with examples as disclosed herein. In some examples, aspects of the operations of 1515 may be performed by a switch component 930 as described with reference to FIG. 9.

At 1520, the method may include transmitting the second CSI associated with the channel for the UE, the second CSI generated in accordance with the second beam management mode based at least in part on the switching. The operations of 1520 may be performed in accordance with examples as disclosed herein. In some examples, aspects of the operations of 1520 may be performed by a beam management component 925 as described with reference to FIG. 9.

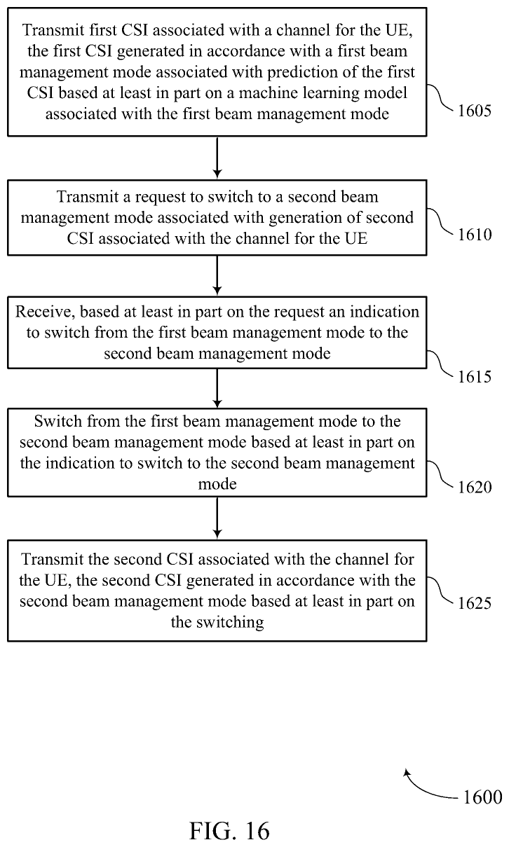

FIG. 16 shows a flowchart illustrating a method 1600 that supports predictive beam management mode switching in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include transmitting first CSI associated with a channel for the UE, the first CSI generated in accordance with a first beam management mode associated with prediction of the first CSI based at least in part on a machine learning model associated with the first beam management mode. The operations of 1605 may be performed in accordance with examples as disclosed herein. In some examples, aspects of the operations of 1605 may be performed by a beam management component 925 as described with reference to FIG. 9.

At 1610, the method may include transmitting a request to switch to a second beam management mode associated with generation of second CSI associated with the channel for the UE. The operations of 1610 may be performed in accordance with examples as disclosed herein. In some examples, aspects of the operations of 1610 may be performed by a request component 935 as described with reference to FIG. 9.

At 1615, the method may include receiving, based at least in part on the request an indication to switch from the first beam management mode to the second beam management mode. The operations of 1615 may be performed in accordance with examples as disclosed herein. In some examples, aspects of the operations of 1615 may be performed by a switch component 930 as described with reference to FIG. 9.

At 1620, the method may include switching from the first beam management mode to the second beam management mode based at least in part on the indication to switch to the second beam management mode. The operations of 1620 may be performed in accordance with examples as disclosed herein. In some examples, aspects of the operations of 1620 may be performed by a switch component 930 as described with reference to FIG. 9.

At 1625, the method may include transmitting the second CSI associated with the channel for the UE, the second CSI generated in accordance with the second beam management mode based at least in part on the switching. The operations of 1625 may be performed in accordance with examples as disclosed herein. In some examples, aspects of the operations of 1625 may be performed by a beam management component 925 as described with reference to FIG. 9.

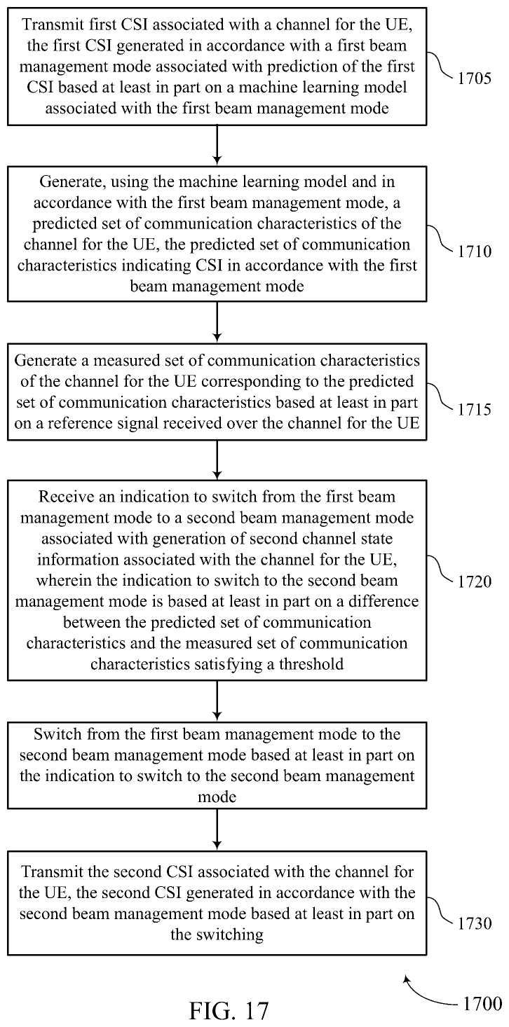

FIG. 17 shows a flowchart illustrating a method 1700 that supports predictive beam management mode switching in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include transmitting first CSI associated with a channel for the UE, the first CSI generated in accordance with a first beam management mode associated with prediction of the first CSI based at least in part on a machine learning model associated with the first beam management mode. The operations of 1705 may be performed in accordance with examples as disclosed herein. In some examples, aspects of the operations of 1705 may be performed by a beam management component 925 as described with reference to FIG. 9.

At 1710, the method may include generating, using the machine learning model and in accordance with the first beam management mode, a predicted set of communication characteristics of the channel for the UE, the predicted set of communication characteristics indicating CSI in accordance with the first beam management mode. The operations of 1710 may be performed in accordance with examples as disclosed herein. In some examples, aspects of the operations of 1710 may be performed by a communication characteristic component 940 as described with reference to FIG. 9.

At 1715, the method may include generating a measured set of communication characteristics of the channel for the UE corresponding to the predicted set of communication characteristics based at least in part on a reference signal received over the channel for the UE. The operations of 1715 may be performed in accordance with examples as disclosed herein. In some examples, aspects of the operations of 1715 may be performed by a communication characteristic component 940 as described with reference to FIG. 9.

At 1720, the method may include receiving an indication to switch from the first beam management mode to a second beam management mode associated with generation of second channel state information associated with the channel for the UE, wherein the indication to switch to the second beam management mode is based at least in part on a difference between the predicted set of communication characteristics and the measured set of communication characteristics satisfying a threshold. The operations of 1720 may be performed in accordance with examples as disclosed herein. In some examples, aspects of the operations of 1720 may be performed by a switch component 930 as described with reference to FIG. 9.

At 1725, the method may include switching from the first beam management mode to the second beam management mode based at least in part on the indication to switch to the second beam management mode. The operations of 1725 may be performed in accordance with examples as disclosed herein. In some examples, aspects of the operations of 1725 may be performed by a switch component 930 as described with reference to FIG. 9.

At 1730, the method may include transmitting the second CSI associated with the channel for the UE, the second CSI generated in accordance with the second beam management mode based at least in part on the switching. The operations of 1730 may be performed in accordance with examples as disclosed herein. In some examples, aspects of the operations of 1730 may be performed by a beam management component 925 as described with reference to FIG. 9.

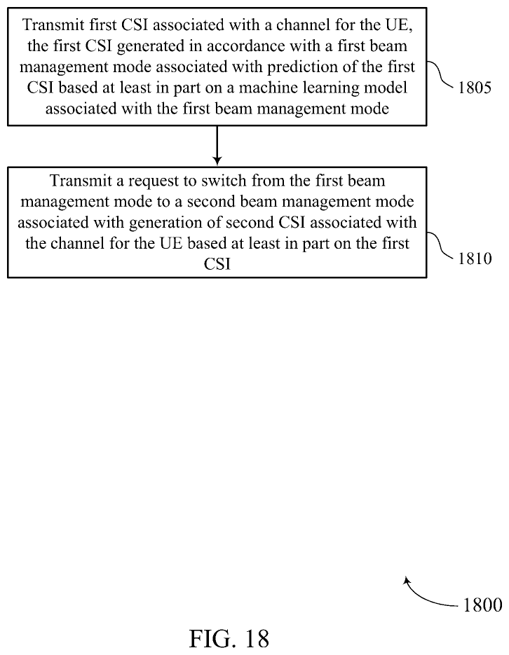

FIG. 18 shows a flowchart illustrating a method 1800 that supports predictive beam management mode switching in accordance with one or more aspects of the present disclosure. The operations of the method 1800 may be implemented by a UE or its components as described herein. For example, the operations of the method 1800 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1805, the method may include transmitting first CSI associated with a channel for the UE, the first CSI generated in accordance with a first beam management mode associated with prediction of the first CSI based at least in part on a machine learning model associated with the first beam management mode. The operations of 1805 may be performed in accordance with examples as disclosed herein. In some examples, aspects of the operations of 1805 may be performed by a beam management component 925 as described with reference to FIG. 9.

At 1810, the method may include transmitting a request to switch from the first beam management mode to a second beam management mode associated with generation of second channel state information associated with the channel for the UE based at least in part on the first CSI. The operations of 1810 may be performed in accordance with examples as disclosed herein. In some examples, aspects of the operations of 1810 may be performed by a switch component 930 as described with reference to FIG. 9.

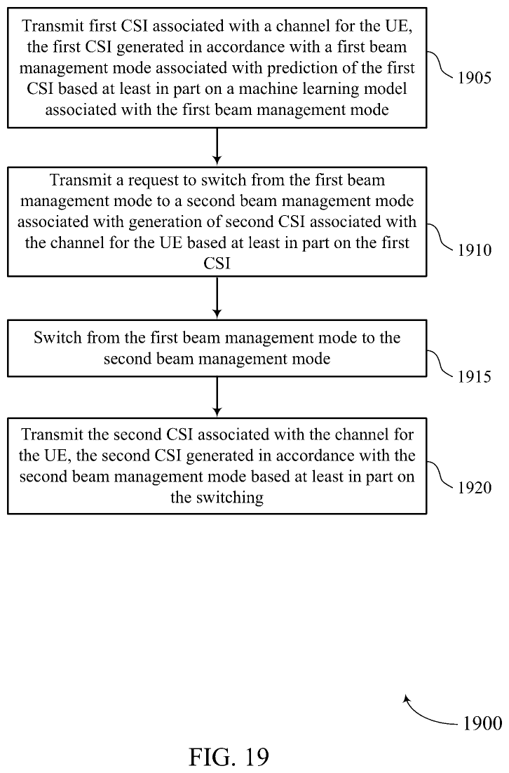

FIG. 19 shows a flowchart illustrating a method 1900 that supports predictive beam management mode switching in accordance with one or more aspects of the present disclosure. The operations of the method 1900 may be implemented by a UE or its components as described herein. For example, the operations of the method 1900 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1905, the method may include transmitting first CSI associated with a channel for the UE, the first CSI generated in accordance with a first beam management mode associated with prediction of the first CSI based at least in part on a machine learning model associated with the first beam management mode. The operations of 1905 may be performed in accordance with examples as disclosed herein. In some examples, aspects of the operations of 1905 may be performed by a beam management component 925 as described with reference to FIG. 9.

At 1910, the method may include transmitting a request to switch from the first beam management mode to a second beam management mode associated with generation of second CSI associated with the channel for the UE based at least in part on the first CSI. The operations of 1910 may be performed in accordance with examples as disclosed herein. In some examples, aspects of the operations of 1910 may be performed by a switch component 930 as described with reference to FIG. 9.

At 1915, the method may include switching from the first beam management mode to the second beam management mode. The operations of 1915 may be performed in accordance with examples as disclosed herein. In some examples, aspects of the operations of 1915 may be performed by a switch component 930 as described with reference to FIG. 9.

At 1920, the method may include transmitting the second CSI associated with the channel for the UE, the second CSI generated in accordance with the second beam management mode based at least in part on the switching. The operations of 1920 may be performed in accordance with examples as disclosed herein. In some examples, aspects of the operations of 1920 may be performed by a beam management component 925 as described with reference to FIG. 9.

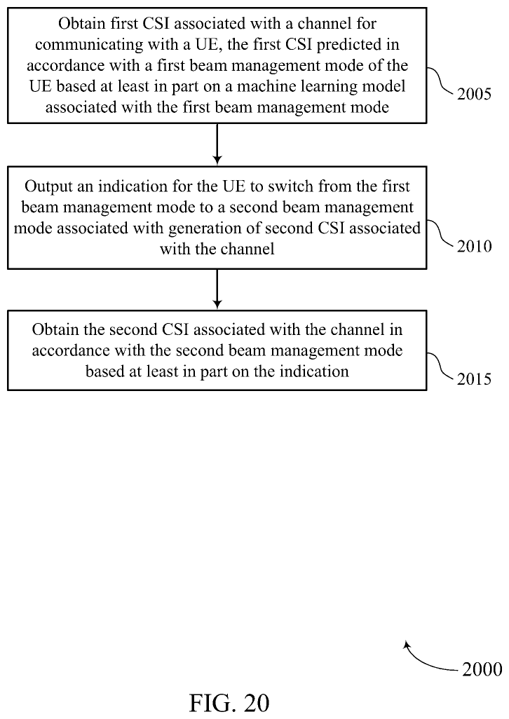

FIG. 20 shows a flowchart illustrating a method 2000 that supports predictive beam management mode switching in accordance with one or more aspects of the present disclosure. The operations of the method 2000 may be implemented by a network entity or its components as described herein. For example, the operations of the method 2000 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2005, the method may include obtaining first CSI associated with a channel for communicating with a UE, the first CSI predicted in accordance with a first beam management mode of the UE based at least in part on a machine learning model associated with the first beam management mode. The operations of 2005 may be performed in accordance with examples as disclosed herein. In some examples, aspects of the operations of 2005 may be performed by a CSI component 1325 as described with reference to FIG. 13.

At 2010, the method may include outputting an indication for the UE to switch from the first beam management mode to a second beam management mode associated with generation of second CSI associated with the channel. The operations of 2010 may be performed in accordance with examples as disclosed herein. In some examples, aspects of the operations of 2010 may be performed by a switch component 1330 as described with reference to FIG. 13.

At 2015, the method may include obtaining the second CSI associated with the channel in accordance with the second beam management mode based at least in part on the indication. The operations of 2015 may be performed in accordance with examples as disclosed herein. In some examples, aspects of the operations of 2015 may be performed by a CSI component 1325 as described with reference to FIG. 13.

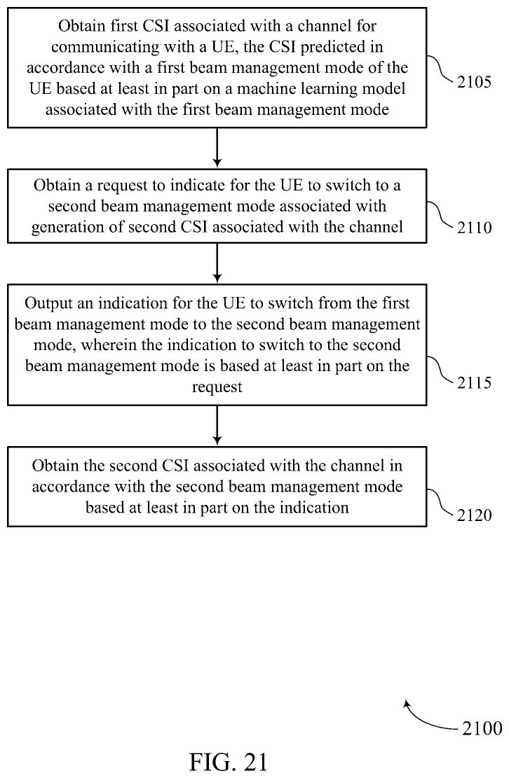

FIG. 21 shows a flowchart illustrating a method 2100 that supports predictive beam management mode switching in accordance with one or more aspects of the present disclosure. The operations of the method 2100 may be implemented by a network entity or its components as described herein. For example, the operations of the method 2100 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2105, the method may include obtaining first CSI associated with a channel for communicating with a UE, the CSI predicted in accordance with a first beam management mode of the UE based at least in part on a machine learning model associated with the first beam management mode. The operations of 2105 may be performed in accordance with examples as disclosed herein. In some examples, aspects of the operations of 2105 may be performed by a channel state information component 1325 as described with reference to FIG. 13.

At 2110, the method may include obtaining a request to indicate for the UE to switch to a second beam management mode associated with generation of second CSI associated with the channel. The operations of 2110 may be performed in accordance with examples as disclosed herein. In some examples, aspects of the operations of 2110 may be performed by a request component 1335 as described with reference to FIG. 13.

At 2115, the method may include outputting an indication for the UE to switch from the first beam management mode to the second beam management mode, wherein the indication to switch to the second beam management mode is based at least in part on the request. The operations of 2115 may be performed in accordance with examples as disclosed herein. In some examples, aspects of the operations of 2115 may be performed by a switch component 1330 as described with reference to FIG. 13.

At 2120, the method may include obtaining the second CSI associated with the channel in accordance with the second beam management mode based at least in part on the indication. The operations of 2120 may be performed in accordance with examples as disclosed herein. In some examples, aspects of the operations of 2120 may be performed by a channel state information component 1325 as described with reference to FIG. 13.

The following provides an overview of aspects of the present disclosure:

Aspect 1: A method for wireless communications at a UE, comprising: transmitting first CSI associated with a channel for the UE, the first CSI generated in accordance with a first beam management mode associated with prediction of the first CSI based at least in part on a machine learning model associated with the first beam management mode: receiving an indication to switch from the first beam management mode to a second beam management mode associated with generation of second CSI associated with the channel for the UE: switching from the first beam management mode to the second beam management mode based at least in part on the indication to switch to the second beam management mode; and transmitting the second CSI associated with the channel for the UE, the second CSI generated in accordance with the second beam management mode based at least in part on the switching.

Aspect 2: The method of aspect 1, further comprising: transmitting a request to switch to the second beam management mode, wherein the indication to switch to the second beam management mode is based at least in part on the request.

Aspect 3: The method of aspect 2, wherein transmitting the request to switch to the second beam management mode comprises: transmitting the request based at least in part on a threshold change between a first output of the machine learning model and a second output of the machine learning model, a threshold change between a measurement of a first reference signal received over the channel for the UE and a measurement of a second reference signal received over the channel for the UE, or a combination thereof.

Aspect 4: The method of any of aspects 1 through 3, further comprising: generating, using the machine learning model and in accordance with the first beam management mode, a predicted set of communication characteristics of the channel for the UE, the predicted set of communication characteristics indicating CSI in accordance with the first beam management mode; and generating a measured set of communication characteristics of the channel for the UE corresponding to the predicted set of communication characteristics based at least in part on a reference signal received over the channel for the UE, wherein the indication to switch to the second beam management mode is based at least in part on a difference between the predicted set of communication characteristics and the measured set of communication characteristics satisfying a threshold.

Aspect 5: The method of aspect 4, wherein the predicted set of communication characteristics and the measured set of communication characteristics each comprise a respective set of spatial domain communication characteristics, a respective set of time domain communication characteristics, a respective set of frequency domain communication characteristics, or a combination thereof.

Aspect 6: The method of any of aspects 4 through 5, further comprising: transmitting a request for transmission of the reference signal; and receiving the reference signal over the channel for the UE in response to the request.

Aspect 7: The method of any of aspects 4 through 6, further comprising: receiving an activation message indicating transmission of the reference signal; and receiving the reference signal over the channel for the UE in response to the activation message.

Aspect 8: The method of any of aspects 4 through 7, further comprising: transmitting a report comprising the predicted set of communication characteristics and the measured set of communication characteristics or comprising an indication of the difference between the predicted set of communication characteristics and the measured set of communication characteristics.

Aspect 9: The method of aspect 8, wherein the indication to switch to the second beam management mode is received in response to the report based at least in part on the difference between the predicted set of communication characteristics and the measured set of communication characteristics satisfying the threshold.

Aspect 10: The method of any of aspects 4 through 9, further comprising: transmitting a request to switch to the second beam management mode based at least in part on a comparison of the predicted set of communication characteristics and the measured set of communication characteristics to determine the difference between the predicted set of communication characteristics and the measured set of communication characteristics, wherein the indication to switch to the second beam management mode is received in response to the request.

Aspect 11: The method of any of aspects 4 through 10, wherein the reference signal is associated with a time instance for which CSI associated with the time instance is configured to be predicted in accordance with the first beam management mode.

Aspect 12: The method of any of aspects 4 through 11, wherein the reference signal is associated with a reference signal resource set for which CSI associated with the reference signal resource set is configured to be predicted in accordance with the first beam management mode.

Aspect 13: The method of any of aspects 1 through 12, wherein the second beam management mode is associated with prediction of the second CSI based at least in part on a second machine learning model associated with the second beam management mode.

Aspect 14: The method of any of aspects 1 through 12, wherein the second beam management mode is associated with generation of the second CSI based at least in part on a measurement of a reference signal received over the channel for the UE.

Aspect 15: The method of any of aspects 1 through 14, wherein the indication to switch to the second beam management mode comprises: an indication to deactivate a first type of CSI report associated with the first beam management mode or a first reference signal resource set associated with the first beam management mode, and an indication to activate a second type of CSI report associated with the second beam management mode or a second reference signal resource set associated with the second beam management mode.

Aspect 16: The method of any of aspects 1 through 15, further comprising: receiving signaling that indicates the machine learning model associated with the first beam management mode, wherein the first CSI is generated using the machine learning model.

Aspect 17: The method of any of aspects 1 through 16, further comprising: generating, using the machine learning model and in accordance with the first beam management mode, a second indication of a set of resources of the channel predicted to have higher communication characteristics relative to other resources of the channel, the communication characteristics comprising respective RSRPs associated with the set of resources, respective SINRs associated with the set of resources, or a combination thereof; and transmitting a report comprising the second indication of the set of resources, wherein the indication to switch to the second beam management mode is based at least in part on the report.

Aspect 18: The method of aspect 17, wherein the report comprises a request to switch to the second beam management mode, wherein the indication to switch to the second beam management mode is based at least in part on the request.

Aspect 19: A method for wireless communications at a UE, comprising: transmitting first CSI associated with a channel for the UE, the first CSI generated in accordance with a first beam management mode associated with prediction of the first CSI based at least in part on a machine learning model associated with the first beam management mode; and transmitting a request to switch from the first beam management mode to a second beam management mode associated with generation of second CSI associated with the channel for the UE based at least in part on the first CSI.

Aspect 20: The method of aspect 19, further comprising: switching from the first beam management mode to the second beam management mode; and transmitting the second CSI associated with the channel for the UE, the second CSI generated in accordance with the second beam management mode based at least in part on the switching.

Aspect 21: The method of aspect 20, further comprising: receiving an indication to switch from the first beam management mode to the second beam management mode based at least in part on the request, wherein the switching is based at least in part on the indication.

Aspect 22: The method of aspect 21, further comprising: generating, using the machine learning model and in accordance with the first beam management mode, a predicted set of communication characteristics of the channel for the UE, the predicted set of communication characteristics indicating CSI in accordance with the first beam management mode; and generating a measured set of communication characteristics of the channel for the UE corresponding to the predicted set of communication characteristics based at least in part on a reference signal received over the channel for the UE, wherein the indication to switch to the second beam management mode is based at least in part on a difference between the predicted set of communication characteristics and the measured set of communication characteristics satisfying a threshold.

Aspect 23: The method of aspect 22, wherein the predicted set of communication characteristics and the measured set of communication characteristics each comprise a respective set of spatial domain communication characteristics, a respective set of time domain communication characteristics, a respective set of frequency domain communication characteristics, or a combination thereof.

Aspect 24: The method of any of aspects 22 through 23, further comprising: transmitting a request for transmission of the reference signal; and receiving the reference signal over the channel for the UE in response to the request for transmission of the reference signal.

Aspect 25: The method of any of aspects 22 through 24, further comprising: receiving an activation message indicating transmission of the reference signal; and receiving the reference signal over the channel for the UE in response to the activation message.

Aspect 26: The method of any of aspects 22 through 25, further comprising: transmitting a report comprising the predicted set of communication characteristics and the measured set of communication characteristics or comprising an indication of the difference between the predicted set of communication characteristics and the measured set of communication characteristics.

Aspect 27: The method of aspect 26, further comprising: receiving an indication to switch from the first beam management mode to the second beam management mode, wherein the indication to switch is received in response to the report based at least in part on the difference between the predicted set of communication characteristics and the measured set of communication characteristics satisfying the threshold.

Aspect 28: The method of any of aspects 22 through 27, wherein transmitting the request is based at least in part on a comparison of the predicted set of communication characteristics and the measured set of communication characteristics to determine the difference between the predicted set of communication characteristics and the measured set of communication characteristics.

Aspect 29: The method of any of aspects 22 through 28, wherein the reference signal is associated with a time instance for which CSI associated with the time instance is configured to be predicted in accordance with the first beam management mode.

Aspect 30: The method of any of aspects 22 through 29, wherein the reference signal is associated with a reference signal resource set for which CSI associated with the reference signal resource set is configured to be predicted in accordance with the first beam management mode.

Aspect 31: The method of any of aspects 21 through 30, wherein the indication to switch to the second beam management mode comprises: an indication to deactivate a first type of CSI report associated with the first beam management mode or a first reference signal resource set associated with the first beam management mode, and an indication to activate a second type of CSI report associated with the second beam management mode or a second reference signal resource set associated with the second beam management mode.

Aspect 32: The method of any of aspects 19 through 31, further comprising: receiving a message denying the switch from the first beam management mode to the second beam management mode based at least in part on the request.

Aspect 33: The method of any of aspects 19 through 32, wherein transmitting the request is based at least in part on a threshold change between a first output of the machine learning model and a second output of the machine learning model, a threshold change between a measurement of a first reference signal received over the channel for the UE and a measurement of a second reference signal received over the channel for the UE, or a combination thereof.

Aspect 34: The method of any of aspects 19 through 33, wherein the second beam management mode is associated with prediction of the second CSI based at least in part on a second machine learning model associated with the second beam management mode.

Aspect 35: The method of any of aspects 19 through 33, wherein the second beam management mode is associated with generation of the second CSI based at least in part on a measurement of a reference signal received over the channel for the UE.

Aspect 36: The method of any of aspects 19 through 35, further comprising: receiving signaling that indicates the machine learning model associated with the first beam management mode, wherein the first CSI is generated using the machine learning model.

Aspect 37: The method of any of aspects 19 through 36, further comprising: generating, using the machine learning model and in accordance with the first beam management mode, an indication of a set of resources of the channel that are predicted to have higher communication characteristics relative to other resources of the channel, the communication characteristics comprising respective RSRPs associated with the set of resources, respective SINRs associated with the set of resources, or a combination thereof, wherein the request to switch to the second beam management mode comprises the indication of the set of resources.

Aspect 38: A method for wireless communications at a network entity, comprising: obtaining first CSI associated with a channel for communicating with a UE, the first CSI predicted in accordance with a first beam management mode of the UE based at least in part on a machine learning model associated with the first beam management mode: outputting an indication for the UE to switch from the first beam management mode to a second beam management mode associated with generation of second CSI associated with the channel; and obtaining the second CSI associated with the channel in accordance with the second beam management mode based at least in part on the indication.

Aspect 39: The method of aspect 38, further comprising: obtaining a request to indicate for the UE to switch to the second beam management mode, wherein the indication to switch to the second beam management mode is based at least in part on the request.

Aspect 40: The method of any of aspects 38 through 39, further comprising: outputting a reference signal over the channel, the reference signal associated with an instance for which CSI associated with the instance is configured to be predicted in accordance with the first beam management mode, wherein the indication for the UE to switch to the second beam management mode is based at least in part on a difference between measured CSI corresponding to the reference signal and predicted CSI corresponding to the reference signal satisfying a threshold.

Aspect 41: The method of aspect 40, further comprising: obtaining a request for transmission of the reference signal, wherein the reference signal is output in response to the request.

Aspect 42: The method of any of aspects 40 through 41, further comprising: outputting an indication of transmission of the reference signal, wherein the reference signal is output after the indication of the transmission of the reference signal is output.

Aspect 43: The method of any of aspects 40 through 42, further comprising: obtaining a report comprising the measured CSI and the predicted CSI or an indication of the difference between the measured CSI and the predicted CSI.

Aspect 44: The method of aspect 43, wherein the indication for the UE to switch to the second beam management mode is output in response to the report based at least in part on the difference between the measured CSI and the predicted CSI satisfying the threshold.

Aspect 45: The method of any of aspects 40 through 44, wherein the reference signal is associated with a time instance for which CSI associated with the time instance is configured to be predicted in accordance with the first beam management mode.

Aspect 46: The method of any of aspects 40 through 45, wherein the reference signal is associated with a reference signal resource set for which CSI associated with the reference signal resource set is configured to be predicted in accordance with the first beam management mode.

Aspect 47: The method of any of aspects 38 through 46, wherein the second beam management mode is associated with prediction of the second CSI based at least in part on a second machine learning model associated with the second beam management mode.

Aspect 48: The method of any of aspects 38 through 46, wherein the second beam management mode is associated with generation of the second CSI based at least in part on a measurement of a reference signal received over the channel for the UE.

Aspect 49: The method of any of aspects 38 through 48, wherein the indication to switch to the second beam management mode comprises: an indication to deactivate a first type of CSI report associated with the first beam management mode or a first reference signal resource set associated with the first beam management mode; and an indication to activate a second type of CSI report associated with the second beam management mode or a second reference signal resource set associated with the second beam management mode.

Aspect 50: The method of any of aspects 38 through 49, further comprising: obtaining a report comprising a second indication of a set of resources of the channel predicted to have higher communication characteristics relative to other resources of the channel, the communication characteristics comprising respective RSRPs associated with the set of resources, respective SINRs associated with the set of resources, or a combination thereof.

Aspect 51: An apparatus for wireless communications at a UE, comprising at least one processor: memory coupled (e.g., operatively, communicatively, functionally, or electrically) to the at least one processor, the memory storing instructions executable by the at least one processor to cause the apparatus to perform a method of any of aspects 1 through 18.

Aspect 52: An apparatus for wireless communications at a UE, comprising at least one means for performing a method of any of aspects 1 through 18.

Aspect 53: A non-transitory computer-readable medium storing code for wireless communications at a UE, the code comprising instructions executable by a processor to perform a method of any of aspects 1 through 18.

Aspect 54: An apparatus for wireless communications at a UE, comprising at least one processor: memory coupled (e.g., operatively, communicatively, functionally, or electrically) to the at least one processor, the memory storing instructions executable by the at least one processor to cause the apparatus to perform a method of any of aspects 19 through 37.

Aspect 55: An apparatus for wireless communications at a UE, comprising at least one means for performing a method of any of aspects 19 through 37.

Aspect 56: A non-transitory computer-readable medium storing code for wireless communications at a UE, the code comprising instructions executable by a processor to perform a method of any of aspects 19 through 37.

Aspect 57: An apparatus for wireless communications at a network entity, comprising at least one processor: memory coupled (e.g., operatively, communicatively, functionally, or electrically) to the at least one processor, the memory storing instructions executable by the at least one processor to cause the apparatus to perform a method of any of aspects 38 through 50.

Aspect 58: An apparatus for wireless communications at a network entity, comprising at least one means for performing a method of any of aspects 38 through 50.

Aspect 59: A non-transitory computer-readable medium storing code for wireless communications at a network entity, the code comprising instructions executable by a processor to perform a method of any of aspects 38 through 50.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone: B alone: C alone: A and B in combination: A and C in combination: B and C in combination: or A, B, and C in combination.

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, deciding, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
transmitting first channel state information associated with a channel for the UE, the first channel state information generated in accordance with a first beam management mode associated with prediction of the first channel state information based at least in part on a machine learning model associated with the first beam management mode;
receiving an indication to switch from the first beam management mode to a second beam management mode associated with generation of second channel state information associated with the channel for the UE;
switching from the first beam management mode to the second beam management mode based at least in part on the indication to switch to the second beam management mode; and
transmitting the second channel state information associated with the channel for the UE, the second channel state information generated in accordance with the second beam management mode based at least in part on the switching.

2. The method of claim 1, further comprising:
transmitting a request to switch to the second beam management mode, wherein the indication to switch to the second beam management mode is based at least in part on the request.

3. The method of claim 2, wherein transmitting the request to switch to the second beam management mode comprises:
transmitting the request based at least in part on a threshold change between a first output of the machine learning model and a second output of the machine learning model, a threshold change between a measurement of a first reference signal received over the channel for the UE and a measurement of a second reference signal received over the channel for the UE, or a combination thereof.

4. The method of claim 1, further comprising:
generating, using the machine learning model and in accordance with the first beam management mode, a predicted set of communication characteristics of the channel for the UE, the predicted set of communication characteristics indicating channel state information in accordance with the first beam management mode; and
generating a measured set of communication characteristics of the channel for the UE corresponding to the predicted set of communication characteristics based at least in part on a reference signal received over the channel for the UE, wherein the indication to switch to the second beam management mode is based at least in part on a difference between the predicted set of communication characteristics and the measured set of communication characteristics satisfying a threshold.

5. The method of claim 4, wherein the predicted set of communication characteristics and the measured set of communication characteristics each comprise a respective set of spatial domain communication characteristics, a respective set of time domain communication characteristics, a respective set of frequency domain communication characteristics, or a combination thereof.

6. The method of claim 4, further comprising:
transmitting a request for transmission of the reference signal; and
receiving the reference signal over the channel for the UE in response to the request.

7. The method of claim 4, further comprising:
receiving an activation message indicating transmission of the reference signal; and
receiving the reference signal over the channel for the UE in response to the activation message.

8. The method of claim 4, further comprising:
transmitting a report comprising the predicted set of communication characteristics and the measured set of communication characteristics or comprising an indication of the difference between the predicted set of communication characteristics and the measured set of communication characteristics.

9. The method of claim 8, wherein the indication to switch to the second beam management mode is received in response to the report based at least in part on the difference between the predicted set of communication characteristics and the measured set of communication characteristics satisfying the threshold.

10. The method of claim 4, further comprising:
transmitting a request to switch to the second beam management mode based at least in part on a comparison of the predicted set of communication characteristics and the measured set of communication characteristics to determine the difference between the predicted set of communication characteristics and the measured set of communication characteristics, wherein the indication to switch to the second beam management mode is received in response to the request.

11. The method of claim 1, further comprising:
generating, using the machine learning model and in accordance with the first beam management mode, a second indication of a set of resources of the channel predicted to have higher communication characteristics relative to other resources of the channel, the communication characteristics comprising respective reference signal received powers associated with the set of resources, respective signal-to-interference-plus-noise ratios associated with the set of resources, or a combination thereof; and
transmitting a report comprising the second indication of the set of resources, wherein the indication to switch to the second beam management mode is based at least in part on the report.

12. The method of claim 11, wherein the report comprises a request to switch to the second beam management mode, wherein the indication to switch to the second beam management mode is based at least in part on the request.

13. The method of claim 1, wherein:
the second beam management mode is associated with prediction of the second channel state information based at least in part on a second machine learning model associated with the second beam management mode, or
the second beam management mode is associated with generation of the second channel state information based at least in part on a measurement of a reference signal received over the channel for the UE.

14. A method for wireless communications at a user equipment (UE), comprising:
transmitting first channel state information associated with a channel for the UE, the first channel state information generated in accordance with a first beam management mode associated with prediction of the first channel state information based at least in part on a machine learning model associated with the first beam management mode; and
transmitting a request to switch from the first beam management mode to a second beam management mode associated with generation of second channel state information associated with the channel for the UE based at least in part on the first channel state information.

15. The method of claim 14, further comprising:
switching from the first beam management mode to the second beam management mode; and
transmitting the second channel state information associated with the channel for the UE, the second channel state information generated in accordance with the second beam management mode based at least in part on the switching.

16. The method of claim 15, further comprising:
receiving an indication to switch from the first beam management mode to the second beam management mode based at least in part on the request, wherein the switching is based at least in part on the indication.

17. The method of claim 16, further comprising:
generating, using the machine learning model and in accordance with the first beam management mode, a predicted set of communication characteristics of the channel for the UE, the predicted set of communication characteristics indicating channel state information in accordance with the first beam management mode; and
generating a measured set of communication characteristics of the channel for the UE corresponding to the predicted set of communication characteristics based at least in part on a reference signal received over the channel for the UE, wherein the indication to switch to the second beam management mode is based at least in part on a difference between the predicted set of communication characteristics and the measured set of communication characteristics satisfying a threshold.

18. The method of claim 17, wherein the predicted set of communication characteristics and the measured set of communication characteristics each comprise a respective set of spatial domain communication characteristics, a respective set of time domain communication characteristics, a respective set of frequency domain communication characteristics, or a combination thereof.

19. The method of claim 17, further comprising:
transmitting a request for transmission of the reference signal; and
receiving the reference signal over the channel for the UE in response to the request for transmission of the reference signal.

20. The method of claim 17, further comprising:
receiving an activation message indicating transmission of the reference signal; and
receiving the reference signal over the channel for the UE in response to the activation message.

21. The method of claim 17, further comprising:
transmitting a report comprising the predicted set of communication characteristics and the measured set of communication characteristics or comprising an indication of the difference between the predicted set of communication characteristics and the measured set of communication characteristics.

22. The method of claim 21, further comprising:
receiving an indication to switch from the first beam management mode to the second beam management mode, wherein the indication to switch is received in response to the report based at least in part on the difference between the predicted set of communication characteristics and the measured set of communication characteristics satisfying the threshold.

23. The method of claim 17, wherein transmitting the request is based at least in part on a comparison of the predicted set of communication characteristics and the measured set of communication characteristics to determine the difference between the predicted set of communication characteristics and the measured set of communication characteristics.

24. The method of claim 17, wherein the reference signal is associated with a time instance for which channel state information associated with the time instance is configured to be predicted in accordance with the first beam management mode, or
the reference signal is associated with a reference signal resource set for which channel state information associated with the reference signal resource set is configured to be predicted in accordance with the first beam management mode.

25. The method of claim 14, further comprising:
generating, using the machine learning model and in accordance with the first beam management mode, an indication of a set of resources of the channel that are predicted to have higher communication characteristics relative to other resources of the channel, the communication characteristics comprising respective reference signal received powers associated with the set of resources, respective signal-to-interference-plus-noise ratios associated with the set of resources, or a combination thereof, wherein the request to switch to the second beam management mode comprises the indication of the set of resources.

26. The method of claim 14, further comprising:
receiving a message denying the switch from the first beam management mode to the second beam management mode based at least in part on the request.

27. The method of claim 14, wherein transmitting the request is based at least in part on a threshold change between a first output of the machine learning model and a second output of the machine learning model, a threshold change between a measurement of a first reference signal received over the channel for the UE and a measurement of a second reference signal received over the channel for the UE, or a combination thereof.

28. The method of claim 14, further comprising:
receiving signaling that indicates the machine learning model associated with the first beam management mode, wherein the first channel state information is generated using the machine learning model.

29. An apparatus for wireless communications at a user equipment (UE), comprising:
at least one processor; and
memory coupled to the at least one processor, the memory storing instructions executable by the at least one processor to cause the apparatus to:
transmit first channel state information associated with a channel for the UE, the first channel state information generated in accordance with a first beam management mode associated with prediction of the first channel state information based at least in part on a machine learning model associated with the first beam management mode;
receive an indication to switch from the first beam management mode to a second beam management mode associated with generation of second channel state information associated with the channel for the UE;
switch from the first beam management mode to the second beam management mode based at least in part on the indication to switch to the second beam management mode; and
transmit the second channel state information associated with the channel for the UE, the second channel state information generated in accordance with the second beam management mode based at least in part on the switch to the second beam management mode.

30. An apparatus for wireless communications at a user equipment (UE), comprising:
at least one processor; and
memory coupled to the at least one processor, the memory storing instructions executable by the at least one processor to cause the apparatus to:
transmit first channel state information associated with a channel for the UE, the first channel state information generated in accordance with a first beam management mode associated with prediction of the first channel state information based at least in part on a machine learning model associated with the first beam management mode; and
transmit a request to switch from the first beam management mode to a second beam management mode associated with generation of second channel state information associated with the channel for the UE based at least in part on the first channel state information.
